(19) United States
(12) Patent Application Publication
(10) Pub. No.: US 2026/0343621 A1
(43) Pub. Date: Oct. 29, 2026

(54) SYSTEMS AND METHODS FOR VIRTUAL REFERENCE SIGNALS IN WIRELESS SYSTEMS

(71) Applicant: InterDigital Patent Holdings, Inc., Wilmington, DE (US)

(72) Inventors: Nazli Khan Beigi, Longueuil (CA); Paul Marinier, Brossard (CA); Ghyslain Pelletier, Montreal (CA); Moon IL Lee, Melville, NY (US); Aata El Hamss, Laval (CA); Tao Deng, New York, NY (US); Jonghyun Park, Syosset, NY (US)

(73) Assignee: InterDigital Patent Holdings, Inc., Wilmington, DE (US)

(21) Appl. No.: 19/193,647

(22) Filed: Apr. 29, 2025

(51) Int. Cl. H04W 74/0833; H04W 24/10; H04W 74/00

(52) U.S. Cl. CPC H04W 74/0833; H04W 24/10; H04W 74/002

(57) ABSTRACT

Methods, apparatuses, and systems are disclosed. In one example, a method performed by a wireless transmit/receive unit (WTRU) may comprise receiving a plurality of reference signals associated; selecting a first reference signal of the plurality of reference signals based on a measured channel quality parameter associated with the first reference signal, wherein the first reference signal is associated with a second reference signal; receiving configuration information associated with random access, wherein the configuration information comprises information associated with virtual reference signals; selecting, from the virtual reference signals, a virtual reference signal to be used for random access based on the first reference signal and the second reference signal; and transmitting a Physical Random-Access Channel (PRACH) preamble via a random access occasion associated with the selected virtual reference signal.

### BACKGROUND

In cellular systems, beam management, beam selection, and beam refinement may take place after a wireless transmit/receive unit (WTRU) is connected to a cell and after the WTRU switches to a Radio Resource Control (RRC) connected mode. The WTRU may receive Channel State Information (CSI) report configurations as a part of RRC configurations. The RRC configurations may indicate one or more Reference Signals (RSs) to be measured and reported. For example, the RSs indicated (e.g., in a CSI report configuration) may be associated with an RS that the WTRU selected based on a Reference Signal Received Power (RSRP) value measured to the selected RS during random access.

### SUMMARY

Methods and apparatuses for operation by a wireless transmit/receive unit (WTRU) are provided.

In an example, a method performed by a WTRU may comprise receiving a plurality of reference signals associated with each other; selecting a first reference signal of the plurality of reference signals based on a measured channel quality parameter associated with the first reference signal, wherein the first reference signal is associated with a second reference signal; receiving configuration information associated with random access, wherein the configuration information comprises information associated with virtual reference signals; selecting, from the virtual reference signals, a virtual reference signal to be used for random access based on the first reference signal and the second reference signal; and transmitting a Physical Random-Access Channel (PRACH) preamble via a random access occasion associated with the selected virtual reference signal.

The first reference signal may be associated with a first beam direction and the second reference signal may be associated with a second beam direction.

The virtual reference signals may, in some examples, not actually be transmitted by a network.

The configuration information may comprise a channel quality threshold associated with the virtual reference signals.

The configuration information may comprise (i) an indication of a first random access configuration associated with the first reference signal and the second references signal and (i) an indication of a second random access configuration associated with the virtual reference signals.

The method may further comprise selecting the virtual reference signal based on the measured channel quality parameter associated with the first reference signal and a measured channel quality parameter associated with the second reference signal.

The method may further comprise sending a report, wherein the report may comprise an indication of (i) the measured channel quality parameter associated with the first reference signal, (ii) a measured channel quality parameter associated with the second reference signal, or (ii) a ratio of the measured channel quality parameter associated with the first reference signal and the measured channel quality parameter associated with the second reference signal.

The plurality of reference signals may be associated with a plurality of reference signal blocks. The first reference signal being associated with the second reference signal may comprise (i) the first reference signal being associated with a first reference signal block of the plurality of reference signal blocks and (ii) the first reference signal block being associated with the second reference signal.

The first reference signal and the second reference signal may be multiplexed in time within the first reference signal block.

A first beam direction associated with the first reference signal may be associated with a wide beam, and a second beam direction associated with the second reference signal may be associated with a differential beam.

A first Transmission Control Indicator (TCI) state may be associated with the first reference signal and the first beam direction, and a second TCI state may be associated with the second reference signal and the second beam direction.

The method may further comprise determining the channel quality parameter for the first reference signal and the channel quality parameter for the second reference signal based on the first TCI state and the second TCI state, respectively.

The first reference signal, the second reference signal, and the virtual reference signal may be associated with different random access occasions.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts a diagram of an example Reference Signal (RS) block.

FIG. 3 depicts a graph that depicts an example relation between a relative phase and a ratio of the measured RSRP based on two associated RSs.

FIG. 4 depicts a diagram that indicates an example of a TCI-state-to-RO mapping.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

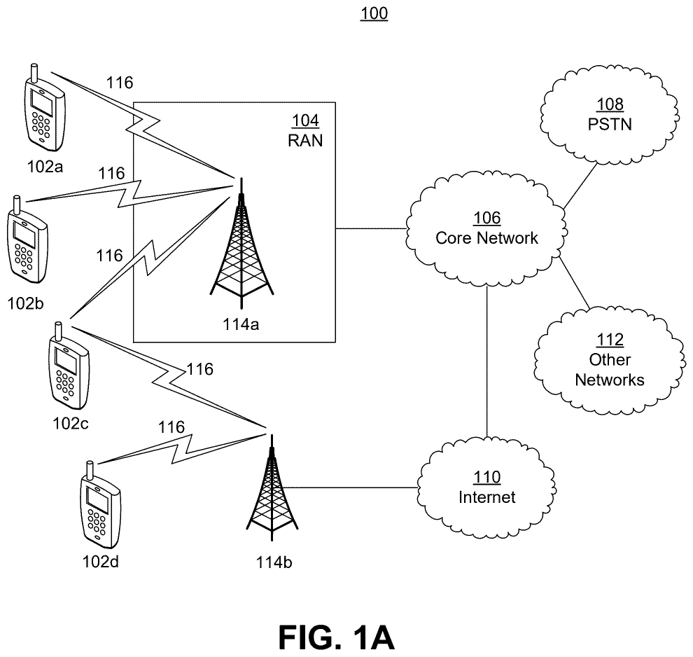

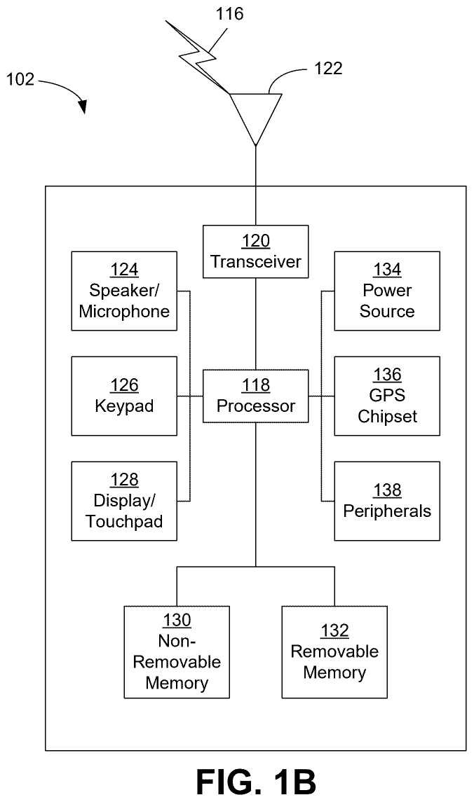

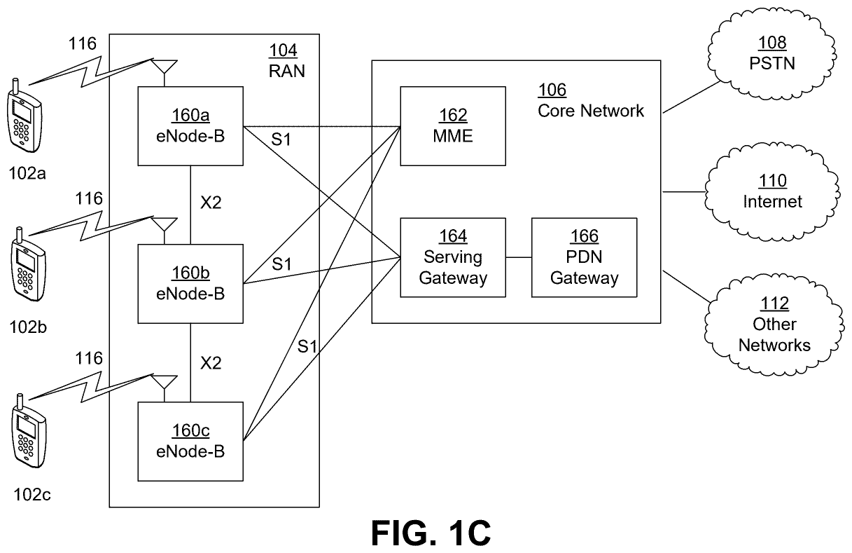

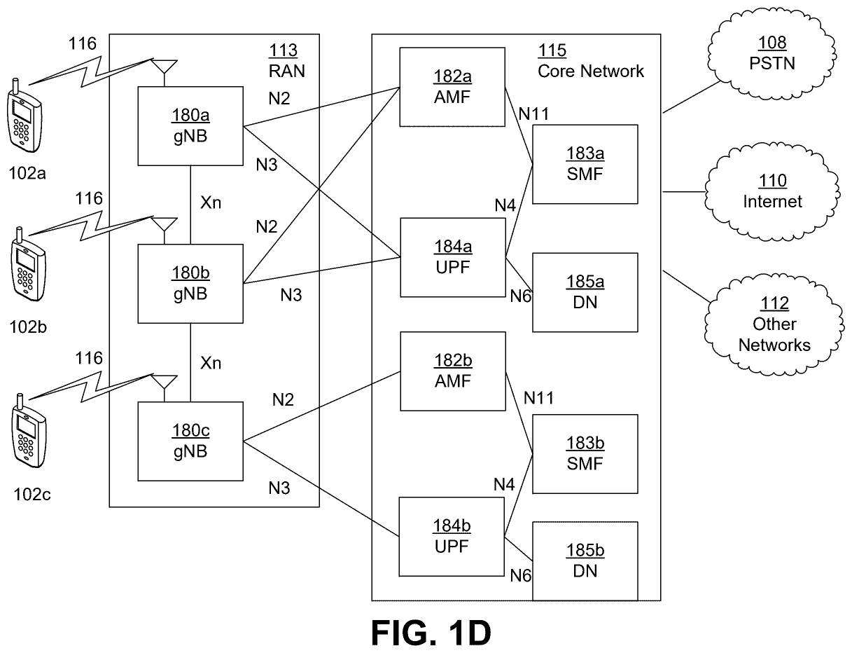

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received (e.g., as indicated by timing information) from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods disclosed herein involve a WTRU that may be configured with a first Reference Signal (RS) and a second RS (e.g., via receiving configuration information that indicates the first RS and the second RS). The first RS and the second RS may be multiplexed in time within an RS block. The WTRU may measure Reference Signal Received Power (RSRP) values based on the first RS and/or the second RS. The WTRU may determine one or more virtual RSs based on the measured RSRP values.

In one example, a WTRU may measure a first RSRP and a second RSRP based on a first RS and a second RS, respectively (e.g., in an RS block). The WTRU may determine one or more virtual RSs based on RSRPs measured by the WTRU. The WTRU may select an RS from among the first RS, the second RS, and/or the virtual RS (e.g., by selecting an RS for which the respective RSRP is higher than the respective RSRPs for the other RSs). The WTRU may select a Random Access (RA) occasion (RO) associated with the selected RS and transmit a PRACH preamble on the selected RO.

In New Radio (NR) wireless systems, a WTRU may determine, be configured (e.g., via receiving configuration information), and/or be indicated to receive, measure, and/or detect one or more RSs (e.g., Synchronization Signal Blocks (SSBs)). The one or more RSs may be from one or more cells. The WTRU may select a cell and select at least one RS (e.g., SSB) from the selected cell based on the detected, measured, and/or received RSs (e.g., SSBs) (e.g., by selecting RS associated with a respective RSRP that is an upper bound of respective RSRPs associated with the detected, measured, and/or received RSs). The WTRU may determine to perform a random-access procedure based on the selected at least one RS (e.g., SSB). For example, the WTRU may transmit (e.g., on a Physical Random-Access Channel (PRACH)) an initial preamble (e.g., Msg 1), a scheduled uplink transmission (e.g., Msg 3), a combined message that comprises an initial preamble and a scheduled uplink transmission (e.g., MsgA), and/or some other type of transmission. The WTRU may receive a Random Access Response (RAR) and may also receive further signaling as part of a random-access procedure. In an example, the WTRU may perform random access (RA) procedure as part of an initial access procedure, beam failure recovery, or some other procedure. In some examples, the WTRU may initiate a random-access procedure based on at least one received Physical Downlink Control Channel (PDCCH) order, where the WTRU may receive configuration information and/or indications on Transmission Control Indicator (TCI) state, PRACH preamble, Random Access Channel (RACH) resources, etc.

An SSB may include at least one of the following: a Primary Synchronization Signal (PSS), a Secondary Synchronization Signal (SSS), a Physical Broadcast Channel (PBCH) (e.g., Data, Master Information Block (MIB)), and/or a PBCH Demodulation Reference Signal (DMRS). SSBs may be transmitted by a Network (NW) node (e.g., a base station, Transmission and Reception Point (TRP), a relay node, a Reconfigurable Intelligent Surface (RIS) unit, etc.) in different beam directions. The number of SSB beams in an SSB burst set, which may be transmitted periodically within an interval (e.g., 5 milliseconds (ms)), may depend on the carrier frequency used to transmit the SSB burst set. For example, an SSB burst may contain 4 SSBs (e.g., in Frequency Range 1 (FR1) for less than 3 gigahertz (GHz)), 8 SSBs (e.g., in FR1 for 3 to 6 GHZ), 64 SSBs (e.g., for Frequency Range 2 (FR2)), and so forth. There may be different types of SSB bursts such as normal always-on (AO) SSB bursts, energy saving(ES) SSB bursts, on-demand (OD) SSB bursts, one-shot SSB bursts, etc. The different types of SSB bursts may possibly comprise a subset of SSBs in a burst, where the subset of SSBs may be transmitted aperiodically, semi-persistently, and/or periodically with certain periodicity.

In NR wireless systems, beam management, beam selection, and/or beam refinement may take place after a WTRU is connected to a cell and/or after the WTRU switches to a Radio Resource Control (RRC)-Connected mode. The WTRU may receive Channel State Information (CSI) report configurations (e.g., indicated by CSI-report-configuration information) as a part of RRC configurations (e.g., indicated by RRC configuration information). The RRC configurations may indicate one or more RSs (e.g., SSBs, CSI reference signal (CSI-RS), etc.) to be measured and/or reported. For example, the RSs configured (e.g., via configuration information received from an NR NodeB (gNB)) in a CSI report configuration may be associated with a selected RS (e.g., selected by the WTRU based on RSRP) (e.g., SSB) during random access. The WTRU may perform measurements on the configured RS resources and/or determine and/or report an RS resource (e.g., that may be optimal based on the measurements performed), as a beam direction (e.g., an optimal beam direction) to be used. The WTRU may report an RS resource index and/or an associated TCI-state, where the RS resource for the reported beam (e.g., beam direction) may be a Quasi Co Location (QCL) RS in the associated TCI state.

In the random-access procedure in NR wireless systems, a WTRU may have to measure several SSB bursts to determine an SSB to be used (e.g., an optimal SSB), since the WTRU's coverage may be affected due to a wide beam transmission of the SSBs. Also, the PRACH preamble transmission (via the WTRU) based on the wide beams during the random-access procedure could potentially result in multiple re-attempts and/or power ramping.

On the other hand, in the beam management procedure, the WTRU may receive configurations on performing beam refinement after the WTRU connects to a cell and/or the WTRU switches to RRC-Connected mode. By the time the WTRU determines, selects, and/or reports the beam to be used (e.g., a narrow and/or optimal beam), there may be a huge latency that may affect performance.

Performing beam refinement early (e.g., before the WTRU switches to RRC-Connected mode) may have the potential to obviate such latency. However, existing systems lack the capability to perform beam refinement early (e.g., before the WTRU switches to RRC-Connected mode). Thus, one problem to be addressed may be how to capacitate a WTRU to perform early beam refinement efficiently.

In current NR wireless systems, the SSB selection that occurs during a random-access procedure may result in a suboptimal beam selection. Optimal beam refinement may take place much later and after a WTRU switches to RRC-Connected mode, resulting in inefficient Reception/Transmission (Rx/Tx) during the random-access procedure with latency penalties. Thus, one problem to consider may be how to enable efficient early beam refinement.

A WTRU may be configured with a first RS and a second RS. The first RS and the second RS may be multiplexed in time within an RS block. The WTRU may measure RSRP values based on the first RS and the second RS and determine one or more virtual RSs based on the measured RSRP values. The WTRU may select an RS (e.g., an optimal or “best” RS) out of the first RS, second RS, and the virtual RSs. The WTRU may send a PRACH preamble based on the selected RS.

Even though the functions of RS (e.g., SSB) selection during a random-access procedure and beam management (e.g., during RRC-Connected mode) may operate independently, the outcomes of each function may affect the other. QCL relations and virtual RSs proposed in this disclosure may facilitate and/or capacitate optimal beam selection earlier (e.g., as early as during an initial access procedure). Also, including more than one TCI-state in an RS block may allow a lower number of TCI states (e.g., a reference TCI-state, differential TCI-states, and/or virtual TCI states).

A WTRU (e.g., in RRC Idle and/or Inactive mode) performing a random-access procedure may detect, receive, and/or measure one or more RSs from one or more RS bursts.

The one or more RSs may be associated (e.g., in a spatial domain), wherein one or more of the RSs may be included in an RS block (e.g., an SSB) from one or more RS block bursts (e.g., SSB bursts).

The RS blocks (e.g., SSBs) in the burst may comprise, for example, a PSS, a PBCH, and/or PBCH DMRS. The RS block may comprise more than one RS.

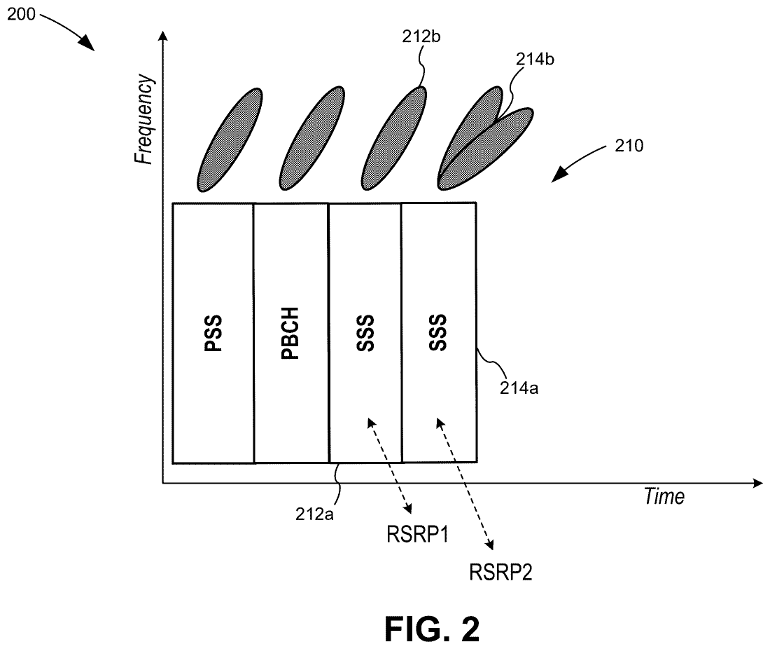

FIG. 2 depicts a diagram 200 of an example RS block 210. The example RS block 210 may comprise a first RS associated with a first SSS 212a and/or with a first beam direction 212b (e.g., first TCI-state). The first beam direction 212b may be associated with a wide beam. In some examples, “wide beam” may refer to a beam with an angular width that is greater than (or, in some examples, equal to) a threshold angular width (e.g., a beam with an angular width greater than thirty degrees or greater than some other threshold angular width). Also, in some examples, “narrow beam” may refer to a beam with an angular width that is less (or, in some examples, equal to) than a threshold angular width (e.g., a beam with an angular width less than ten degrees or less than some other threshold angular width).

The example RS block 210 may comprise a second RS associated with a second SSS 214a and/or with a second beam direction 214b (e.g., second differential TCI-state). The second beam direction 214b may be associated with a differential beam and/or a narrow beam). The differential beam direction 214b may be based on the first beam direction 212b (e.g., the differential beam direction may deviate by a certain number of degrees from the first beam direction). Although two possible differential beams are shown by 214b, the WTRU may use only one differential beam for transmission and/or reception.

The first RS and the second RS may be multiplexed in time within the RS block 210.

The WTRU may select a first RS (e.g., associated with a second RS) (e.g., from an RS block) from the RS block burst (e.g., best RS, e.g., with the highest measured RSRP).

The WTRU may measure a first RSRP (“RSRP1”) and a second RSRP (“RSRP2”) based on the first selected RS and the associated second RS (e.g., in the selected RS block), respectively. The WTRU may use the first TCI-state (e.g., based on the first RS) for measuring the first RSRP and the second RSRP.

The WTRU may monitor, detect, and/or receive a Control Resource Set (CORESET) (e.g., CORESET #0) and/or a System Information Block (SIB) (e.g., SIB1) based on the beam direction associated with the first selected RS.

The WTRU may receive RA configuration information via the received SIB (e.g., SIB1). The RA configuration information may comprise a first set of RA configurations for RA based on the first RS and/or the second RS. The RA configuration information may further comprise one or more threshold values for determining a set of third (e.g., virtual) RSs. The RA configuration information may further comprise a separate second set of RA configurations for RA based on the third (e.g., virtual) RSs. The RA configuration information may further comprise other RA configuration information, such as indications of time and/or frequency resources, threshold values, repetition configurations, power configurations, and/or an RS-to-RO mapping, among other possible types of configuration information.

The WTRU may select an RS and/or beam direction (e.g., an optimal RS and or beam direction) for an RA procedure.

In some examples, the WTRU may select the RS and/or beam direction based on the actual first RS and/or second RS. For instance, if the measured first RSRP is higher than the measured second RSRP, the WTRU may select the first RS for the RA procedure. If the measured second RSRP is higher than the measured first RSRP, the WTRU may select the second RS for the RA procedure.

In some examples, the WTRU may select the RS and/or beam direction based on virtual RSs. For instance, a first virtual RS (VRS #1) may be the ratio of the measured first RSRP (RSRP1) to the second measured RSRP (RSRP2) (e.g., the quotient defined be the expression RSRP1/RSRP2) within a first interval (e.g., [R1, R2]) and a same phase. A second virtual RS (VRS #2) may be the ratio of the measured first RSRP (RSRP1) to the second measured RSRP (RSRP2) (e.g., the quotient defined be the expression RSRP1/RSRP2) within a second interval (e.g., [R2, R3]) and the same phase. A third virtual RS (VRS #3) may be the ratio of the measured first RSRP

(RSRP1) to the second measured RSRP (RSRP2) (e.g., the quotient defined be the expression RSRP1/RSRP2) within the first interval (e.g., [R1, R2]) and a reversed phase. Virtual RSs may also be defined in other ways.

The WTRU may select an RA occasion (RO) associated with the selected RS and transmit a PRACH preamble on the selected RO.

In some examples, the WTRU may report information on (e.g., comprising, regarding, and/or associated with) the measured RSRPs, ratio(s) of first RSRP and the second RSRP, etc. Based on the reports, a base station (e.g., a gNB that receives the report(s) sent by the WTRU) may determine a fine-tuned beam direction towards the WTRU and may later transmit, for example, a beamformed (e.g., WTRU-specific) CSI-RS to the WTRU.

Hereinafter, ‘a,’ ‘an,’ and/or similar phrases may be interpreted as ‘one or more’ and/or ‘at least one.’ Similarly, any term which ends with the suffix ‘(s)’ may be interpreted as ‘one or more’ and/or ‘at least one.’ The term ‘may’ may be interpreted as ‘may, for example.’

A symbol ‘/’ (e.g., forward slash) may be used herein to represent ‘and/or.’ For example, ‘A/B’ may imply ‘A and/or B’.

In some examples, a WTRU may transmit or receive a physical channel and/or reference signal according to at least one spatial domain filter. The term “beam” may be used to refer to a spatial domain filter.

In some examples, the WTRU may transmit a physical channel and/or signal using the same spatial domain filter as the spatial domain filter used for receiving an RS (such as a CSI-RS) or an SS block. The WTRU transmission may be referred to as the “target,” and the received RS and/or SS block may be referred to as the “reference” and/or “source.” In such an example, the WTRU may be said to transmit the target physical channel and/or signal according to a spatial relation with a reference to such an RS and/or SS block.

In some examples, the WTRU may transmit a first physical channel and/or signal according to the same spatial domain filter as the spatial domain filter used for transmitting a second physical channel and/or signal. The first transmission and the second transmission may be referred to as the “target” and “reference” (or “source”), respectively. In such an example, the WTRU may be said to transmit the first (e.g., target) physical channel and/or signal according to a spatial relation with a reference to the second (e.g., reference) physical channel and/or signal.

In some examples, a spatial relation may be implicit, configured by RRC, and/or signaled by MAC Control Element (CE) or Downlink Control Information (DCI). For example, a WTRU may implicitly transmit a Physical Uplink Shared Channel (PUSCH) and/or a DM-RS of the PUSCH according to the same spatial domain filter as a Sounding Reference Signal (SRS) indicated by an SRS Resource Indicator (SRI) indicated in DCI and/or configured by RRC. In another example, a spatial relation may be configured by RRC for an SRI and/or signaled by MAC CE for a Physical Uplink Control Channel (PUCCH). Such a spatial relation may also be referred to as a “beam indication.”

The WTRU may receive a first (e.g., target) downlink channel and/or signal according to the same spatial domain filter and/or spatial reception parameter as a second (e.g., reference) downlink channel and/or signal. For example, an association may exist between a physical channel such as a Physical Downlink Control Channel (PDCCH) or Physical Downlink Shared Channel (PDSCH) and its respective DM-RS. At least when the first signal and the second signal are reference signals, such an association may exist when the WTRU is configured with a quasi-colocation QCL assumption type D (e.g., QCL-Type-D) between corresponding antenna ports. Such an association may be configured as a TCI state. A WTRU may be indicated an association between a CSI-RS and/or SS block and/or a DM-RS by an index to a set of TCI states configured by RRC and/or signaled by MAC CE. Such an indication may also be referred to as a “beam indication.”

A WTRU may receive TCI-related configuration(s) (e.g., in the form of TCI-related configuration information). The TCI-related configuration(s) may comprise a plurality of TCI states (e.g., an RRC-configured pool of TCI states—e.g., as unified TCI framework), a ‘TCI-State’ Information element (IE), a ‘TCI-UL-State’ IE, a ‘spatialRelationInfo’ IE, and/or other types TCI-related configuration information. A TCI state of the plurality of TCI states may be associated with (e.g., comprise) at least one of QCL-info #1, QCL-info #2, additionalPCI, pathloss RS (e.g., Pathloss Reference Signal (PLRS))-ID, UL-PC, Timing Advance Group (TAG)-ID, where QCL-info #1 (or QCL-info #2) may comprise a cell ID (e.g., serving-cell index), a BWP-ID, an RS (e.g., CSI-RS, SSB-index), and/or a QCL-type which may be one of typeA, typeB, typeC, or typeD. In an example, the PLRS-ID may be for pathloss estimation for determining an Uplink (UL) transmission power when a UL transmission is based on a TCI-state that may be associated with the PLRS-ID. In an example, the UL Power Control (UL-PC) (e.g., UL-PC parameter set, which may comprise at least one of PO, alpha, close-loop (CL)-index, power offset, etc.) may be for determining an uplink power for a UL transmission associated with the TCI-state. In an example, an additional Physical Cell Identity (PCI) may be a physical cell-ID (PCID) of a neighboring (surrounding) cell that the RS (associated with the TCI-state) (e.g., SSB-index or CSI-RS) may be transmitted from, (e.g., as an inter-cell beam (or RS) reference). In an example, the WTRU may apply a timing advance value (e.g., based on received timing advance command (TAC) (s)) in association with a Timing Advance Group Identity (TAG-ID) (e.g., of multiple TAG-IDs being configured) to a scheduled UL transmission.

In some examples, type-A (e.g., QCL-type-A) may represent {Doppler shift, Doppler spread, average delay, delay spread}. Furthermore, typeB e.g., QCL-type-B) may represent {Doppler shift, Doppler spread}, typeC e.g., QCL-type-C) may represent {Doppler shift, average delay}, and/or typeD e.g., QCL-type-D) may represent {Spatial Rx parameter}.

When a WTRU receives an indication and/or configuration (e.g., configuration information) of a TCI-state (e.g., applicable for a physical channel and/or signal) comprising a QCL-type (e.g., typeA, typeB, typeC, or typeD) and/or an RS (e.g., an RS associated with the QCL-type), the WTRU may determine (e.g., derive) at least one parameter for transmission and/or reception, the at least one parameter representing wireless channel characteristics (e.g., at least one of Doppler shift, Doppler spread, average delay, delay spread, and/or a spatial Rx parameter) based on the indicated QCL-type, and/or apply the at least one parameter for transmission and/or reception of the physical channel or signal.

A unified TCI (e.g., a common TCI, a common beam, a common RS, etc.) may refer to a beam and/or RS to be (e.g., simultaneously and/or concurrently) used for multiple physical channels and/or signals. The term “TCI” may at least comprise a TCI state that includes at least one source RS to provide a reference (e.g., WTRU assumption) for determining QCL and/or spatial filter.

In an example, a WTRU may receive (e.g., from a base station such as a gNB) an indication of a first unified TCI to be used and/or applied for both a downlink control channel (e.g., PDCCH) and a downlink shared channel (e.g., PDSCH) (e.g., and, in some examples, a downlink RS). The source reference signal(s) in the first unified TCI may provide common QCL information for at least WTRU-dedicated reception on the PDSCH and/or all (or subset of) CORESETs in a Control Channel (CC). In an example, the WTRU may receive (e.g., from a base station such as a gNB) an indication of a second unified TCI to be used and/or applied for both an uplink control channel (e.g., PUCCH) and an uplink shared channel (e.g., PUSCH) (e.g., and an uplink RS). The source reference signal(s) in the second unified TCI may provide a reference for determining common UL Transmission (TX) spatial filter(s) for at least a dynamic-grant/configured-grant-based uplink shared channel and/or all (or subset of) dedicated uplink control channel resources in a CC.

The WTRU may be configured with a first mode for unified TCI (e.g., SeparateDLULTCI mode, a parameter of ‘unifiedTCI-StateType’ set to ‘separate’) wherein an indicated unified TCI (e.g., the first unified TCI or the second unified TCI) may be applicable for either downlink (e.g., based on the first unified TCI) or uplink (e.g., based on the second unified TCI).

In an example, the WTRU may receive (e.g., from a base station (BS), a gNB, a TRP, etc.) an indication of a second unified TCI to be used and/or applied commonly for a PDCCH, a PDSCH, a PUCCH, and/or a PUSCH (and a DL RS and/or a UL RS).

The WTRU may be configured with a second mode for unified TCI (e.g., JointTCI mode, a parameter of ‘unifiedTCI-StateType’ set to ‘joint’), wherein an indicated unified TCI (e.g., the third unified TCI) may be applicable for both downlink and uplink (e.g., based on the third unified TCI).

The WTRU may determine a TCI state applicable to a transmission or reception by first determining a Unified TCI state instance (e.g., TCI-state group, a group of TCI-states, a set of activated TCI-states) applicable to this transmission and/or reception, then determine a TCI state corresponding to the Unified TCI state instance. A transmission may comprise at least a PUCCH, a PUSCH, and/or an SRS. A reception may comprise at least a PDCCH, a PDSCH, and/or a CSI-RS. A Unified TCI state instance may also be referred to as a TCI state group, a TCI state process, a unified TCI pool, a group of TCI states, a set of time-domain instances/stamps/slots/symbols, a set of frequency-domain instances/RBs/subbands, etc. A Unified TCI state instance may be equivalent and/or identified to a Coreset Pool identity (e.g., CORESETPoolIndex, a TRP indicator, and/or the like).

Hereafter, “unified TCI” may be interchangeably referred to as one or more of unified TCI-states, unified TCI instance, TCI, and/or TCI-state, but may still be consistent with examples described herein.

A WTRU may be configured with a plurality of TCI states (e.g., unified TCI (UTCI) states), each applicable for multiple channel(s)/signal(s). The multiple channel(s)/signal(s) may be configured to the WTRU (or pre-determined or defined—e.g., in a form of a list), by a higher-layer signaling (e.g., RRC and/or MAC CE) which may comprise at least one of following: one or more CORESETs, one or more PDCCH candidates, one or more search spaces, one or more PDSCHs (e.g., PDSCH occasions/configurations/instances, etc.), one or more RSs (e.g., CSI-RSs, DMRSs, SSB indexes, PRSs, PTRSs, and/or SRSs), one or more PUSCHs (e.g., PUSCH occasions/configurations/instances, etc.), one or more PUCCH resources (e.g., PUCCH resource sets/groups), and/or one or more PRACH occasions/resources/RSs.

The plurality of TCI states may be configured via RRC signaling (e.g., and/or via a MAC-CE signaling, indication and/or activation). The WTRU may receive (e.g., via a MAC-CE or a separate signaling), information comprising a mapping between one or more codepoints of a DCI field (e.g., TCI field and/or TCI selection field) and/or at least one TCI state of the plurality of TCI states. The WTRU may receive a DCI comprising the DCI field. The WTRU may be indicated with one or more TCI states, of the plurality of TCI states, mapped to a codepoint of the one or more codepoints of the DCI field, wherein each of the one or more TCI states may be applicable after a time duration determined based on a beam application time (BAT) parameter.

Hereafter, “TRP” may be interchangeably used with one or more of TP (transmission point), RP (reception point), RRH (radio remote head), DA (distributed antenna), BS (base station), a sector (of a BS), and/or a cell (e.g., a geographical cell area served by a BS), but may still be consistent with examples described herein. Hereafter, “multi-TRP” may be interchangeably used with one or more of MTRP, M-TRP, and/or multiple TRPs, but may still be consistent with examples described herein.

A WTRU may be configured with (e.g., may receive configuration information indicating) one or more TRPs to which the WTRU may transmit and/or from which the WTRU may receive. The WTRU may be configured with one or more TRPs for one or more cells. A cell may be a serving cell and/or secondary cell.

A WTRU may be configured with at least one RS for the purpose of channel measurement. This RS may be denoted as a Channel Measurement Resource (CMR) and may comprise a CSI-RS, an SSB, and/or other downlink RS transmitted from the TRP to the WTRU. A CMR may be configured and/or associated with a TCI state. A WTRU may be configured with a CMR group where CMRs transmitted from the same TRP may be configured. Each group may be identified by a CMR group index (e.g., group 1). A WTRU may be configured with one CMR group per TRP, and the WTRU may receive a linkage between one CMR group index and another CMR group index, or between one RS index from one CMR group and another RS index from another group.

A WTRU may be configured with (e.g., may receive configuration information indicating) one or more pathloss (PL) reference groups (e.g., sets) and/or one or more SRS groups, SRI and/or SRS resource sets.

A PL reference group may correspond to and/or be associated with a TRP. A PL reference group may include, identify, correspond to and/or be associated with one or more TCI states, SRIs, reference signal sets (e.g., CSI-RS set, SRI sets, etc.), CORESET index(es), and/or or reference signals (e.g., CSI-RS, SSB, etc.).

A WTRU may receive a configuration (e.g., any configuration described herein). The configuration may be received from a BS (e.g., gNB) and/or TRP. For example, the WTRU may receive a configuration of (e.g., configuration information indicating) one or more TRPs, one or more PL reference groups, and/or one or more SRI sets. The WTRU may implicitly determine an association between an RS set/group and a TRP. For instance, if the WTRU is configured with two SRS resource sets, then the WTRU may determine to transmit to a TRP (e.g., TRP1) with an SRS in the first resource set, and/or to another TRP (e.g., TRP2) with an SRS in the second resource set. The configuration (e.g., configuration information) may be received via RRC signaling.

In examples described herein, the terms “TRP,” “PL reference group,” “SRI group,” and/or “SRI set” may be used interchangeably. The terms “set” and “group” may be used interchangeably in examples described herein.

A WTRU may report a subset of channel state information (CSI) components, wherein CSI components may correspond to at least a CSI-RS resource indicator (CRI), an SSB resource indicator (SSBRI), an indication of a panel used for reception at the WTRU (such as a panel identity or group identity), measurements such as L1-RSRP, L1 Signal-to-Interference-plus-Noise Ratio (SINR) (L1-SINR) taken from an SSB or a CSI-RS (e.g., cri-RSRP, cri-SINR, ssb-Index-RSRP, ssb-Index-SINR), and/or other channel state information such as a rank indicator (RI), a channel quality indicator (CQI), a precoding matrix indicator (PMI), a Layer Index (LI), etc.

A WTRU may be operating during one or more RRC states and/or RRC modes (e.g., RRC-Connected state, RRC-Inactive state, and/or RRC-Idle state).

In an example, a WTRU may be operating in an RRC-Connected state, during which the WTRU may have connected, established RRC context, and/or have at least one RRC connection (e.g., to one or more cells, base stations, gNBs, TRPs, etc.). In RRC-Connected state, the WTRU may receive RRC context and/or configuration information comprising one or more of radio bearers, logical channels, Protocol Data Unit (PDU) sessions, security information, etc. During RRC-Connected state, the connected WTRU may measure one or more of RSRP, reference signal received quality (RSRQ), received signal strength indicator (RSSI), etc. based on one or more received, detected, configured, and/or indicated RSs received from a serving cell and/or one or more neighboring cells. The connected WTRU may report the measured parameters (e.g., to the serving cell).

In an example, a WTRU may be operating in an RRC-Idle state (e.g., that may be the initial mode when the WTRU is powered up). The WTRU in RRC-Idle state may be in a dormant state wherein the WTRU is not actively engaged in communication. The WTRU in RRC-Idle state may perform cell selection and/or cell reselection, wherein the WTRU may receive, detect, measure, and/or select an SSB, based on which the WTRU may use the PBCH, MIB, SIB, etc. The WTRU in RRC-Idle state may monitor a PDCCH (e.g., DCI, Format 1-0 using a Paging Radio Network Temporary Identifier (P-RNTI)) defined by ta Discontinuous Reception (DRX) pattern. The WTRU may use a respective Temporary Mobile Subscriber Identity (TMSI) (e.g., 5G-S-TMSI) to receive Paging messages in RRC-Idle state.

In an example, a WTRU may be operating in an RRC-Inactive state, wherein the WTRU may keep the RRC context and CORE network connection and not release the RRC when switching from an RRC-Connected state to an RRC-Inactive state. The WTRU in RRC-Inactive state may be in a sleep mode, similar to RRC-Idle state, wherein mobility may be handled through cell reselection without involvement of a network.

A WTRU may receive, identify, and/or be configured with (e.g., via configuration information) one or more (e.g., consecutive) RACH Occasions (ROs). The RACH configurations may be indicated via one or more indexes corresponding to one or more tables that comprise random access parameters. Several examples of types of configurations may be included (e.g., in the RACH configurations) are discussed below.

In an example, a RACH configuration may indicate frame number(s), subframe number(s), and/or slot number(s). For example, the WTRU may be configured with time-domain allocations, subframe number, and/or slot numbers during which the ROs may be configured. Using such parameters, the WTRU may determine one or more RO slots (for example, within the corresponding subframe) wherein the WTRU may transmit a configured PRACH preamble in one or more of the determined ROs.

In an example, a RACH configuration may indicate a starting symbol. For example, the WTRU may determine a symbol-level index corresponding to the starting position of a first RO's transmission within an indicated and/or configured RO slot.

In an example, a RACH configuration may indicate a number of PRACH slots. For example, the WTRU may receive an indication of the number of PRACH slots within a reference slot.

In an example, a RACH configuration may indicate a number of time-domain PRACH occasions within a PRACH slot. For example, the WTRU may be configured with a number of consecutive ROs that may be located within a PRACH slot in the time domain.

In an example, a RACH configuration may indicate a PRACH duration. For example, the WTRU may be configured with the duration of an RO (e.g., wherein the duration may be measured in a number of symbols).

In an example, a RACH configuration may indicate a preamble format. For example, the WTRU may be configured with a preamble format selected from a set of possible preamble formats (e.g., A1, A2, A3, B1, A1/B1, A2/B2, A3/B3, B4, CO, C2). The preamble format may identify a corresponding Cyclic Prefix (CP) duration, a sequence part duration, a guard time duration (if applicable), etc.

In an example, a RACH configuration may indicate a frequency start. For example, the frequency start may indicate an offset of a lowest PRACH transmission occasion (e.g., lowest frequency) in the frequency domain with respect to a reference (e.g., PRB 0).

In an example, a RACH configuration may indicate Frequency-Division Multiplexed (FDMed) ROs. For example, the FDM-ed ROs may indicate a number of PRACH transmission occasions that may be FDMed in one time-domain RO. The WTRU may receive, identify, and/or be configured with the number of ROs in the frequency domain (M) per each time-domain PRACH occasion (e.g., wherein M may be such that M={one, two, four, eight}). The WTRU may determine the number of the PRACH frequency resources {0, 1, . . . , M−1}, starting from the lowest frequency, in increasing order in the (e.g., initial) uplink Bandwidth Part (BWP).

In an example, a RACH configuration may indicate a preamble received target power. For example, the WTRU may receive an indication of an initial random access preamble power (e.g., for the transmission of Msg 1 and/or Msg A).

In an example, a RACH configuration may indicate an RSRP threshold for a repetition number X (e.g., of Msg1 or MsgA). For example, the WTRU may receive configuration information indicating the RSRP threshold. Based on the RSRP threshold, the WTRU may determine to perform PRACH preamble repetition for X times (e.g., iterations). In an example, if the WTRU determines that a measured DL pathloss RSRP is lower than the received threshold for repetition number X, the WTRU may perform PRACH repetition for X times (e.g., iterations).

In an example, a RACH configuration may indicate a power ramping step. For example, the WTRU may use power ramping step for increasing the PRACH transmission power up to a configured maximum number of times (e.g., iterations) (e.g., preambleTransMax) or until a RAR is received.

In an example, a RACH configuration may indicate a maximum number of preamble transmissions (e.g., preambleTransMax). For example, the WTRU may be configured with a maximum number of Random Access Preamble transmissions (e.g., Y). The WTRU may increase the UL transmission power at each PRACH transmission occasion based on the power ramping step. In an example, a WTRU that is configured with a repetition number X may perform PRACH repetition for X times (e.g., iterations), wherein the WTRU may transmit each repetition up to Y times (e.g., iterations) (e.g., wherein Y may be the configured maximum number of Random Access Preamble transmissions). The WTRU may stop PRACH transmission if a RAR is received. If a RAR is not received, and/or the maximum number of preamble transmissions is reached, the WTRU may switch to performing repetitions with a next available higher repetition number.

A RACH configuration may also comprise other types of information.

A WTRU may receive an association (e.g., relation) and/or mapping between the RS and/or RS block indexes and the ROs based on one or more parameters indicating a number of RS and/or RS block indexes associated with an RO within an RS-to-RO mapping cycle. In an example, a RACH association period (e.g., starting from frame zero) for mapping RS and/or RS block indexes to ROs may be the smallest integer number in a set determined by a PRACH configuration period, such that the RS and/or RS block indexes may be mapped at least once to the ROs within the association period.

The WTRU may determine a PRACH power (e.g., for PRACH preamble transmission). The WTRU may determine the PRACH power based on one or more of configuration information, an indication, and/or measured parameters. In an example, the WTRU may determine the PRACH power based on a configured preamble received target power (e.g., PREAMBLE_RECEIVED_TARGET_POWER); a determined, measured, and/or calculated pathloss; a power ramping counter; a power ramping step, etc. The WTRU may limit the PRACH power to be no greater than a threshold (e.g., maximum) power (e.g., Pcmax).

In an example, the WTRU may determine a maximum output power the WTRU may use for a transmission based on one or more of the following: the WTRU's power class maximum power, power reductions allowed for meeting requirements such as emissions and/or Specific Absorption Rate (SAR) requirements, reductions related to tolerances, a signaled maximum power (e.g., Pcmax), etc.

Hereafter, the term “signal” may be interchangeably used with one or more of following: SRS, CSI-RS, DMRS, Phase Tracking Reference Signal (PT-RS), and/or SSB, but may still be consistent with examples described herein.

Hereafter, the term “channel” may be interchangeably used with one or more of following: PDCCH, PDSCH, PUCCH, PUSCH, and/or PRACH, but may still be consistent with examples described herein.

Hereafter, the term “downlink reception” may be used interchangeably with Rx occasion, PDCCH, PDSCH, and/or SSB reception, but may still be consistent with examples described herein.

Hereafter, the term “uplink transmission” may be used interchangeably with Tx occasion, PUCCH, PUSCH, PRACH, and/or SRS transmission, but may still be consistent with examples described herein.

Hereafter, the term “RS” may be interchangeably used with RS resource, RS resource set, RS port, and/or RS port group, but may still be consistent with examples described herein.

Hereafter, the term “RS” may also be interchangeably used with SSB, CSI-RS, SRS, PT-RS, Tracking Reference Signal (TRS), and/or DMRS, but may still be consistent with examples described herein.

Hereafter, the term “time instance” may be interchangeably used with slot, symbol, and/or subframe, but may still be consistent with examples described herein.

Hereafter, the term “UTCI” may be interchangeably used with TCI, UTCI state, and/or TCI state, but may still be consistent with examples described herein.

Hereinafter, the terms received signal power, received signal energy, received signal strength, SSB Energy Per Resource Element (EPRE), CSI EPRE, RSRP, RSSI, SINR, RSRQ, SS-RSRP, SS-RSSI, SS-SINR, SS-RSRQ, CSI-RSRP, CSI-RSSI, CSI-SINR, and/or CSI-RSRQ may be used interchangeably, but may still be consistent with examples described herein.

Herein, the phrases ‘WTRU is configured,’ ‘WTRU is indicated,’ ‘WTRU receives configuration,’ and/or so forth, may imply that a configuration is indicated, for example, ‘via RRC, MAC-CE, DCI, MIB, SIB, and/or so forth,’ unless indicated otherwise, where for example, ‘WTRU is configured’ may imply ‘WTRU is configured via RRC, MAC-CE, MIB, SIB, and/or so forth.’

Hereafter, for the brevity of discussion, the channel quality parameters may comprise Radio Resource Management (RRM) measurements. However, examples in this disclosure may equally (or equivalently, extendedly, etc.) be employed (e.g., be applicable) for cases involving other quality parameters and/or values (e.g., RSRP, RSRQ, SNR, SINR, etc.).

A WTRU may be configured with one or more reference signals (RSs), where the configured RSs may be associated. For example, the WTRU may receive configuration information indicating the configured RSs and their association. In an example, the WTRU may be in RRC-Idle mode or RRC-Inactive mode. In an example, the WTRU may receive configuration information indicating a first RS (e.g., SSB, CSI-RS resource), a second RS, and so forth. In an example, the first RS may have a QCL relation (e.g., Type D) with a first TCI state. In an example, the first RS may be based on a wide beam. In another example, the second RS may have a QCL relation (e.g., Type D) with a second TCI state. In an example, the second RS may be based on a narrow beam. In another example, a configured third RS may have a QCL relation (e.g., Type D) with a third TCI state, wherein the third RS may be based on a differential relation with respect to a first beam (e.g., the wide beam). For instance, the third RS may be based on a beam (e.g., a differential beam) that may be correlated with the first beam (e.g., via a difference in angle of arrival (AoA), angle of departure (AoD), etc.).

In an example, the WTRU may be configured with (e.g., receive configuration information indicating) one or more RS blocks. For example, the WTRU may be configured with one or more RSs that may be multiplexed in time and/or frequency in a configured RS block. In an example, the RS block may include one or more indications and/or configuration information (e.g., information bits) in addition to one or more RSs. The RS block may include a first RS, a second RS, and/or other elements. The RSS, indications, and/or configurations (e.g., information bits) may be multiplexed in time and/or frequency based on configured resource mappings (e.g., resource elements (REs) in one or more physical resource blocks (PRBs)). In an example, the RS resources included in an RS block may be associated with each other. For example, the second RS resource may be associated with the first RS resource (e.g., by virtue of being included in the same RS block).

In an example, a first RS resource may be associated with a first TCI state and/or a second RS resource may be associated with a second TCI state. For example, the second TCI state may be associated with the first TCI state, where a spatial filter used to send and/or receive based on the second TCI state may have a relation (e.g., a differential relation) with a spatial filter used to send and/or receive based on the first TCI state. In another example, the first RS and/or the first TCI-state may be based on a wide beam, whereas the second RS and/or the second TCI-state may be based on a narrow beam.

In an example, an RS block may be associated with an RS block index, wherein the WTRU may determine the RS block's index based on one or more information bits included in the RS block. In another example, one or more RS blocks may be transmitted in one or more RS block bursts. For instance, one or more RS blocks may be transmitted consecutively in configured time and/or frequency resources within a configured time duration. The RS block burst may be transmitted periodically, aperiodically, and/or semi-persistently. The WTRU may be configured with and/or receive configuration information indicating a time, a frequency, an order of the one or more RS blocks, a time duration, a periodicity, etc. with respect to the one or more RS blocks.

In an example, the WTRU may be configured with one or more SSBs, where one or more SSBs may be transmitted in one or more SSB bursts. An SSB may include one or more PSSs, PBCHs, DMRSs, and/or SSSs.

As noted above, FIG. 2 depicts the diagram 200 of the RS block 210 (e.g., which may be an SSB). The RS block 210 may comprise a PSS, a PBCH, a PBCH DMRS and/or two SSSs 216, 218. The first SSS 216 may be associated with a first RS and the second SSS 218 may be associated with a second RS. The WTRU may measure one or more quality parameters based on the first RS and the second RS. For example, the quality parameters may include RRM measurements, RSRP, RSSI, RSRQ, SINR, etc. In an example, the WTRU may measure a first RSRP based on the first RS and a second RSRP based on the second RS.

In an example, a WTRU may receive configuration information indicating RSs, RS blocks, an association of RSs, etc. from a BS, for example, via RRC, MAC-CE, DCI, and/or SIB as part of the received RS block, and so forth.

In an example, a WTRU may receive configuration information comprising one or more indications of the associated RSs (e.g., the associations between RSs). The one or more indications may be implicit or explicit.

For example, the WTRU may receive one or more indications of the associated RSs and/or associated RS pairs. In an example, configuration information indicating the first RS resource may include the RS-index of the second RS resource as an associated RS resource (e.g., AssociatedRSresourceID). The configuration information indicating the second RS may include the RS-index of the first RS as an associated RS, and/or so forth. In another example, the WTRU may receive a table and/or list of RS pairs and/or RS-index pairs that may be associated. For example, the first RS-index in the indicated RS-index pair may correspond to a first RS and the second RS-index in the indicated RS-index pair may correspond to a second RS that may be associated with the first RS. In an example, the RS index may correspond to a CSI-RS resource index, a CSI-RS resource set index, a TCI-state, an SSB index, etc. with regards to the corresponding RS.

In an example, the configuration information indicating a first RS resource set may include an index to a second RS resource set (e.g., as the associated RS resource set—e.g., AssociatedRSresourceSetID). For example, the WTRU may determine, be configured with, and/or receive an indication that there is an association between the RS resources configured in the first RS resource set and the RS resources in the second RS resource set. In an example, the WTRU may be configured with and/or receive an indication that there is a one-to-one association between the RS resources in the first RS resource set and the RS resources in the second RS resource set.

In an example, the WTRU may be configured with and/or receive an indication that there may be a one-to-many association between the RS resources in the first RS resource set and the RS resources in the second RS resource set. For instance, each RS resource in the first RS resource set may be associated with more than one RS resources in the second RS resource set. In an example, in such cases, the WTRU that has selected a first RS resource (e.g., to be used in a first mode of operation) may determine the second RS resource from the second RS resource set, (e.g., to be used in a second mode of operation) based on one or more measured and/or evaluated parameters. In an example, the measured parameters may be based on the first RS. In another example, the measured parameters may be based on at least one of the second RS resources in the second RS resource set. For example, the measured parameters may include RSRP, RSSI, SINR, RSRQ, PMI, LI, etc. In an example, the evaluated parameters may be based on the first RS and/or the second RS. For example, the evaluated parameters may include a ratio and/or a difference between an RSRP measured based on the first RS and an RSRP measured based on the second RS, a difference and/or a ratio between an AoA measured based on the first RS and an AoA measured based on the second RS, a difference and/or a ratio between a pathloss measured based on the first RS and a pathloss measured based on the second RS, and so forth.

In an example, the WTRU may be configured with and/or may receive an indication that there may be a many-to-one association between the RS resources in the first RS resource set and the RS resources in the second RS resource set. For instance, more than one RS resource in the first RS resource set may be associated with an RS resource in the second RS resource set. In an example, in such cases, the WTRU that has selected at least one of the first RS resources (e.g., to be used in a first mode of operation) may use the second RS resource (e.g., in a second mode of operation).

In an example, the WTRU may receive a table and/or list of RS pairs and/or RS-index pairs that may be associated. For example, a first RS index in the indicated RS-index pair may correspond to a first RS and a second RS index in the indicated RS-index pair may correspond to a second RS that may be associated with the first RS. In an example, the RS index (e.g., the first RS index or the second RS index) may correspond to a CSI-RS resource index, a CSI-RS resource set index, a TCI-state, an SSB index, or another type of index, with regard to the corresponding RS.

In an example, the WTRU may implicitly determine an association between one or more RS resources based on one or more configurations, indications, and/or conditions. In an example, if the WTRU receives, is configured with, and/or receives an indication to receive RS blocks, the WTRU may determine, be configured with, and/or receive an indication that the RS resources included in the RS block may be associated with each other. For instance, if an RS block includes more than one RS resource, the WTRU may determine that the RS resources in the RS block are associated (e.g., with each other).

Other types of indications of the associated RSs (e.g., the associations between RSs) are also possible.

In the following paragraphs, the concept of virtual RSs will be described. A WTRU may estimate, identify, and/or select one or more virtual RSs based on detecting, receiving, and/or measuring one or more transmitted RSs. The virtual RSs may be based on actual configured RSs, wherein, for example, the corresponding actual RSs are not being transmitted by a base station (e.g., for power saving purposes). A WTRU may estimate the corresponding actual RSs that are not being transmitted based on measuring RSs that are being transmitted (e.g., even if few RSs are being transmitted). On the other hand, the virtual RSs may be non-existing, non-actual RSs that are based on assumptions (e.g., virtual assumptions). The WTRU may determine, be configured, and/or receive an indication to use the virtual RSs for one or more use cases. For example, the WTRU may use the virtual RSs as reference RSs for a UL spatial filter and/or a DL spatial filter, a TCI-state, and/or beam selection, determination (and/or reporting) CSI measurement and/or reporting, beam tuning, beam management, pathloss determination, etc. In another example, the WTRU may use the virtual RSs as reference RSs for a random-access procedure, RACH Occasion (RO) selection, etc.

Hereafter, several example types of virtual RSs are discussed. However, the examples in the disclosure may equally (or equivalently or extendedly, etc.) be employed (e.g., applicable) for cases involving other types of RSs (e.g., transmitted RSs, measured RSs, configured RSs, etc.).

In an example, a WTRU may determine, identify, evaluate, and/or estimate one or more parameters for one or more second-type RS resources based on one or more parameters that may be configured, received, detected, and/or measured based on one or more first-type RS resources. The WTRU may determine the parameters for the second-type RS resources based on the measured parameters based on the first-type RS resources in addition to one or more determined, configured, and/or indicated threshold values. For example, the WTRU may receive configuration information indicating one or more first-type RSs (e.g., transmitted RSs) and/or more second-type RSs (e.g., virtual RSs). In an example, the WTRU may be configured receive the configuration information from a base station (e.g., via RRC, MAC-CE, DCI, SIB, as part of RS block information bits, etc.).

In an example, the WTRU may receive configuration information indicating first-type RS resources. For instance, a WTRU may be configured with one or more RS resources. In an example, the WTRU may be configured with a first RS resource set (e.g., transmitted RS resource set) including one or more first-type RS resources (e.g., transmitted RS resources). Each RS resource of the one or more first-type RS resources may be configured with one or more of: a reference RS for QCL Type-A/B/C, a reference RS for QCL Type-D, a resource mapping (e.g., REs in a PRB), a power control offset, a power control offset with respect to a reference RS, a scrambling ID, a periodicity and/or offset, etc. In an example, a first-type RS resource may be associated with one or more first-type RS resources. In an example, the WTRU may be configured to receive, detect, and/or measure a first RS and a second RS, wherein the second RS may be associated with the first RS. In another example, the WTRU may receive configuration information indicating one or more second RSs that are associated with the selected first RS.

In an example, the WTRU may receive configuration information indicating second-type RS resources: For example, the WTRU may be configured with a second RS resource set (e.g., virtual RS resource set). The second RS resource set may be configured with one or more second-type RS resources and/or logical beam IDs. For example, each RS resource of the one or more second-type RS resources may be configured with one or more of: a reference RS for QCL Type A, a logical beam ID for QCL Type D, etc. In another example, the configuration information indicating the second-type RS resources may comprise at least one of a resource ID, a resource identification, a resource index, and so forth. For the second-type RS resources, the WTRU may ignore (or may not be configured with) one or more of a resource mapping (e.g., REs in a PRB), a power control offset, a scrambling ID, a periodicity, an offset, etc.

In an example, the WTRU may receive configuration information indicating whether to enable (e.g., activate) or disable (e.g., deactivate) use of virtual RSs. For example, the WTRU may receive, be configured and/or receive an indication to enable or disable use of virtual RSs as reference RSs (e.g., for beam selection, beam management, CSI measurement and/or reporting, UL or DL spatial filter determination, and/or so forth).

In an example, the WTRU may receive an explicit indication of whether to enable or disable use of virtual RSs. For example, the WTRU may be configured with and/or receive a flag indication, wherein a first value (e.g., zero) of the flag indication may indicate disabling using virtual RSs and a second value (e.g., one) of the flag indication may indicate enabling using virtual RSs.

In an example, the WTRU may receive an implicit indication of whether to enable or disable use of virtual RSs. For example, the WTRU may be configured with one or more thresholds, based on which the WTRU may (e.g., implicitly) determine whether to enable or disable use of virtual RSs. The one or more thresholds may apply to a measured receive power (e.g., RSRP, RSSI), a measured interference (e.g., SINR), a WTRU rotation, a WTRU movement, a WTRU speed, etc.

In an example, the WTRU may determine to use the virtual RSs if the measured RSRP is higher than a configured threshold value (e.g., if the WTRU is closer to the center of a cell). The WTRU may determine not to use the virtual RSs if the measured RSRP is lower than the configured threshold value (e.g., if WTRU is far from the center of the cell).

In an example, the WTRU may receive configuration information indicating threshold values for determining virtual RSs. For example, the WTRU may receive, be configured with, and/or receive an indication of one or more threshold values and/or conditions for measured parameters and/or functions thereof. The WTRU may use the one or more threshold values for determining one or more second-type RSs based on one or more received and/or measured first-type RSs.

In an example, the one or more threshold values may comprise thresholds on (e.g., that apply to) the measured parameters. For instance, the WTRU may receive threshold values on one or more measured parameters based on the first-type RSs (e.g., RSRP, AoA, RSSI, SINR, etc.).

In an example, the one or more threshold values may comprise a difference between the measured parameters. For instance, the WTRU may receive threshold values on (e.g., that apply to) a difference between one or more measured parameters based on one or more first-type RSs. For example, the WTRU may use the thresholds on (e.g., that apply to) the measured parameters based on a first RS and/or a second RS and/or additional RSs. For example, the thresholds on (e.g., that apply to) the measured parameters may comprise a difference between measured RSRP values, a difference between AoA values, a difference between RSSI values, a difference between SINR values, or a difference between another type of values.

In an example, the WTRU may receive an indication of threshold values on (e.g., defining) one or more ranges of one or more measured parameters based on a reference first-type RS. For example, the WTRU may receive an indication of threshold values that apply to a corresponding measured parameter to determine if a corresponding measured parameter value based on a second RS is within a range (e.g., a range indicated by the threshold values) with respect to a corresponding measured parameter value based on a first RS. For example, the first RS and the second RS may be first-type RSs. In an example, the WTRU may determine whether a measured RSRP value based on a second RS may be within the range of a measured RSRP value based on a first RS, based on one or more configured corresponding threshold values. For example, the threshold values may indicate the range for the measured RSRP, AoA, RSSI, SINR, etc.

In an example, the WTRU may receive an indication of a ratio of measured parameters. For instance, the WTRU may receive an indication of threshold values on a ratio of one or more measured parameters based on a first RS and/or a second RS and/or additional RSs, wherein the first RS and the second RS may be first type RSs. For example, the thresholds (e.g., that apply to the ratio of measured parameters) may indicate a difference between measured RSRP values, AoA values, RSSI values, SINR values, etc.

The WTRU may also receive indications of other types of threshold values.

In an example, the WTRU may receive configuration information indicating a random-access procedure (e.g., RACH procedure). The configuration information may include a time and/or frequency resource mapping for RACH occasions (ROs), frequency-domain multiplexed ROs, association period(s), power configurations, repetition thresholds, an RS-to-RO mapping, etc.

In an example, the WTRU may receive configuration information that indicates more than one set of RACH configurations. For example, the WTRU may use a first set of RACH configurations if the WTRU performs the random-access procedure based on a first RS. The WTRU may use a second set of RACH configurations if the WTRU performs the random-access procedure based on the received associated second RS. The WTRU may use a third set of RACH configurations if the WTRU performs the random-access procedure based on one or more virtual RSs.

In an example, the different RACH configurations (e.g., the different sets of RACH configurations) may be configured separately (e.g., such that the different RACH configurations and/or sets of RACH configurations may have different time and/or frequency resource allocations, power configurations, periodicities, numbers of PRACH per slot, etc.).

In another example, the different RACH configurations (e.g., the different sets of RACH configurations) may be configured jointly, such that commonalities between the RACH configurations are not redundantly indicated for each RACH configuration and differences between the RACH configuration are indicated separately. For example, the WTRU may receive a first set of RACH configurations in addition to one or more indications of one or more parameters for determining the second set of RACH configurations and/or third set of PRACH configurations. In an example, the indicated parameters may comprise values for PRACH target power, values for a power ramping step, threshold values for a number of repetitions, etc.

In another example, the WTRU may receive a first set of RACH configurations in addition to one or more indications of one or more offset values and/or scaling factors. For example, the WTRU may use indicated offset values and/or scaling values for determining the second RACH configuration and/or the third RACH configuration with respect to the received first RACH configuration. For example, the indicated offset values and/or scaling values may include time offsets and/or frequency offsets, PRACH target power offsets, power ramping step offsets, offset values for one or more threshold values, and/or other types of offsets.

In an example, the WTRU may receive configuration information that indicates CORESETs and/or search spaces associated with a TCI-state application mode. For instance, the WTRU may be configured with one or more CORESETs and/or search spaces associated with different RS types. For example, (i) a first CORESET and/or search space may be associated with a set of first-type RSs and (ii) a second

CORESET and/or search space may be associated with a set of second-type RSs. For example, the WTRU may monitor and/or receive CORESETs and/or search spaces associated with a corresponding RS type based on a spatial filter, a TCI-state, and/or QCL relations associated with the corresponding RS type.

In an example, the WTRU may receive configuration information that indicates one or more TCI states. Each TCI state may be a first-type TCI state or a second-type TCI state. In an example, a first-type TCI state may be associated with first-type RSs and a second-type TCI state may be associated with second-type RSs. In another example, if a first-type RS resource is configured as a QCL Type-D reference RS, the indicated TCI state may be a first-type TCI state, and if a second-type RS resource is configured as a QCL Type-D reference RS, the TCI state may be a second-type TCI state.

The WTRU may also receive other types of configuration.

In an example, a WTRU may determine one or more virtual RSs based on the received, configured, and/or indicated configurations that indicate the association of one or more RSs in addition to one or more determined, configured, and/or indicated threshold values. The WTRU may receive the configuration information comprising the threshold values, for example, from a base station (e.g., via RRC, MAC-CE, DCI, SIB, as part of an RS block, etc.).

In an example, a WTRU may be configured to receive, detect, and/or measure a first RS and a second RS, wherein the second RS may be associated with the first RS. For example, the WTRU may determine and/or estimate one or more virtual RSs based on the first RS and the second RS and/or based on corresponding measurements. In an example, the WTRU may measure one or more quality parameters based on the first RS and the associated second RS. For example, the quality parameters may comprise RSRP, RSSI, SINR, RSRQ, etc. The WTRU may evaluate one or more functions and/or relations between the configured RSs. In an example, a function may be based on comparing values of the measured quality parameters (e.g., for the different RSs) such as the difference between the values of the measured quality parameters, a ratio between the values of the measured quality parameters, a range of the values of the measured quality parameters, etc. The WTRU may select a virtual RS based on the one or more evaluated functions and/or relations based on one or more of the configured threshold values.

In an example, a WTRU may select a first virtual RS (e.g., as a ‘best’ and/or optimal beam) (e.g., from the set of configured second-type RSs) if the output of a function is higher than a first threshold. The WTRU may select a second virtual RS if the output of the function is lower than the first threshold and higher than a second threshold. The WTRU may select a third virtual RS if the output of the function is lower than the second threshold and higher than a third threshold, and so forth. The WTRU may use a selected RS and/or a corresponding RS index for beam selection and/or reporting, as a reference RS for UL/DL TCI-states, for beam management and/or beam refinement, for evaluating the pathloss, for CSI measurement and/or reporting, and so forth.

In an example, a function may be based on a ratio of the measured RSRP based on a first RS resource and a second RS resource. For example, the WTRU may measure a first RSRP (e.g., a first RSRP value) based on the first RS and a second RSRP (e.g., a second RSRP value) based on the second RS. The WTRU may select a first virtual RS if the ratio of the first RSRP to the second RSRP is within a first interval if the ratio is higher than a first threshold and lower than (and/or equal to) a second threshold, wherein the first RS and the second RS may have the same phase and/or direction (e.g., with respect to an angle of arrival). The WTRU may select a second virtual RS if the ratio of the first RSRP to the second RSRP is within a second interval if the ratio is higher than the second threshold and lower than (and/or equal to) a third threshold, where the first RS and the second RS may have the same phase. The WTRU may select a third virtual RS if the ratio of the first RSRP to the second RSRP is within the first interval, wherein the first RS and the second RS may have a reversed phase and/or direction (e.g., relative to each other) (e.g., with respect to an angle of arrival), and so forth.

In an example, a function may be based on (e.g., measured, calculated, and/or estimated based on) a relative phase between measured RSRPs (e.g., measured RSRP values), a difference between the measured RSRPs, a sum of the measured RSRPs, a ratio of the difference between the measured RSRPs over the sum of the measured RSRPs, measured phases, etc. based on one or more RS resources. For example, the WTRU may measure a first RSRP (e.g., a first RSRP value) based on the first RS and a second RSRP based on the second RS, and a relative phase ($) between the first RS and the second RS. The WTRU may then determine an angle estimate theta (θ) such that the result of a function f(θ) may be as close as possible to (e.g., within a margin of error of) a ratio (e.g., voltage ratio) between the first RS and the second RS.

$$( e . g . , {e}^{j \cdot ϕ} \cdot \sqrt{\frac{first RSRP}{second RSRP}} ,$$

where j may represent the square root of negative one). Such a ratio may be referred to as a “monopulse” ratio used in monopulse radar applications. The function f(θ) may also depend on at least one parameter K. For instance, in one example, a configured function f(θ) may be represented by the following equation:

f(θ)=−j· tan(K· sin(θ))

The WTRU may select a first virtual RS if the angle estimate (θ) is within a first interval, select a second virtual RS if the angle estimate (θ) is within a second interval, and so forth. Bounds of an interval (e.g., the first interval and/or the second interval) may be configured separately for each virtual RS. In another example, the WTRU may determine bounds of an interval for an n^{th} virtual RS (where n may be a non-negative integer) based on a configured total interval (e.g., θₘₐₓ-θₘᵢₙ) over the virtual RSs and/or the number N of configured virtual RSs (e.g., wherein the virtual RSs may correspond to respective intervals of equal size). For example, an n^{th} virtual RS may correspond to the interval defined by the expression

$${θ}_{m i n} + n \cdot ( \frac{{θ}_{m ax} - {θ}_{m i n}}{N} ) .$$

The above examples utilizing RSRP values and/or relative phase of a first RS and a second RS may be beneficial, for example, if a network uses an appropriate spatial filter for transmission of the first RS and the second RS. For example, the first RS may correspond to a sum of two adjacent beams, while the second RS may correspond to a difference between two adjacent beams.

The WTRU may receive (e.g., obtain) configuration(s) for the type(s) of function(s) and/or the at least one parameter and/or intervals from, for example, a physical layer, a MAC and/or RRC signaling. For example, the WTRU may obtain such a configuration from system information (e.g., MIB or SIB).

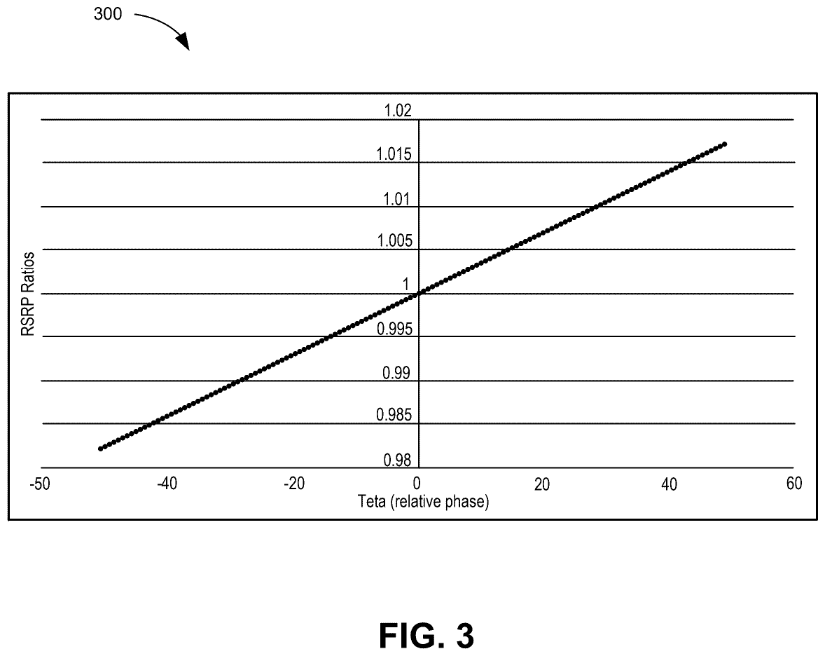

FIG. 3 depicts a graph 300 that depicts an example relation 310 between a relative phase (e.g., “teta”) and a ratio of the measured RSRP based on two associated RSs. In FIG. 3, the first RS may be considered as a reference RS and the second RS may be considered as an associated and/or differential RS. The relation 310 shows how a ratio of the measured RSRPs (e.g., indicated via the vertical axis of the graph 300) based on the first RS and the second RS may contribute to a relative phase (e.g., indicated via the horizontal axis of the graph 300) of the second RS with regard to (e.g., relative to) the first RS. In this example, as the difference between the measured RSRPs (e.g., ratio between the measured RSRPs) increases, the relative phase between the RSs also increases (e.g., as shown by the relation 310). For example, when the measured RSRPs are the same (e.g., the RSRP ratio is equal to one), the two RSs may be in the same direction (e.g., have the same beam direction), resulting in relative phase equal to zero.

In the paragraphs below, methods for supporting virtual RSs are described. A WTRU may determine, be configured, and/or receive an indication to perform a random-access procedure. For example, the WTRU may be in an RRC-Idle state or an RRC-Inactive state. While in the RRC-Idle state or the RRC-Inactive state, the WTRU may determine, be configured, and/or receive an indication to perform a random-access procedure (e.g., an initial access procedure). The WTRU may perform the random-access procedure based on one or more measured RSs (e.g., SSB, CSI-RS, etc.). The WTRU may measure one or more quality parameters based on the one or more RSs. The WTRU may select a first RS based on the measured one or more quality parameters. For example, the WTRU may select an RS with a highest measured RSRP (e.g., compared to respective measured RSRPs for the other RSs in the one or more RSs) and/or lowest measured interference value (e.g., compared to respective measured interference values for the other RSs in the one or more RSs). In an example, if the selected first RS is transmitted as part of a first RS block, the WTRU may select the first RS block (e.g., as a “best” RS block).

In an example, the WTRU may receive configuration information corresponding to the selected first RS (e.g., wherein the configuration information may comprise one or more indications corresponding to the selected first RS). In an example, the WTRU may receive the configuration information as part of a first RS block bit information, if configured. In another example, the WTRU may receive the configuration information via RRC, MAC-CE, DCI, SIB, etc. For instance, the WTRU may receive a SIB (e.g., that the configuration information comprises) by monitoring a CORESET (e.g., CORESET #0) that may be associated with the selected first RS. For example, the WTRU may use a spatial filter determined for receiving the first RS for detecting and/or receiving the CORESET #0. The WTRU may determine that a second RS is associated with the first RS and that the WTRU is enabled to use virtual RSs (e.g., the WTRU is the capability to use virtual RSs and that the capability is activated in the WTRU) based on the association and/or relationship between the first RS and the second RS. The WTRU may determine one or more virtual RSs and/or select a virtual RS based on one or more measured parameters based on the first RS and/or the second RS.

The WTRU may determine to perform the random-access procedure based on the selected first RS and/or a selected virtual RS. The WTRU may determine RACH occasions and/or an RS-to-RO mapping. In some examples, the WTRU may report the measurements (e.g., measured parameters and/or measured quality parameters) based on the first RS, the second RS, the output of one or more evaluated functions, and/or the selected virtual RS resource. The WTRU may use the one or more virtual RSs after connecting to the cell and/or switching to the RRC-Connected state (e.g., mode).

A WTRU may select an RS and determine to perform a random-access procedure based on a selected RS and a corresponding RS resource index. In an example, the selected RS may be a first-type RS (e.g., a transmitted RS), a second-type RS (e.g., a virtual RS), or some other type of RS. The WTRU may receive configuration information regarding the random-access procedure. The configuration information regarding the random-access procedure may indicate one or more RO types. For example, the WTRU may be configured with a first RO type, wherein the first RO type may be associated with first-type RSs. Furthermore, the WTRU may be configured with a second RO type, where the second RO type may be associated with second-type RSs. The WTRU may also be configured with other RO types that are associated with other types of RSs, respectively. In an example, the WTRU may receive indications of whether joint or separate RS-to-RO mapping is enabled (e.g., activated) or disabled (e.g., deactivated) for different RO types. In another example, the configuration information may indicate whether joint or separate PRACH configurations are configured for different RO types. The WTRU may receive the configuration information, for example, from a base station (e.g., via RRC, MAC-CE, DCI, SIB, as part of an RS block, etc.).

In an example, the WTRU may receive one or more explicit indications of whether joint or separate RS-to-RO mapping is enabled (e.g., activated) or disabled (e.g., deactivated) for different RO types. For example, the WTRU may receive one or more flag indications. A first value (e.g., a value of one) for a flag indication may indicate that separate RACH configurations and/or separate RS-to-RO mapping may be used for different RO types. A second value (e.g., a value of zero) for a flag indication may indicate that joint RACH configurations and/or joint RS-to-RO mapping may be used for different RO types.

In an example, the WTRU may receive one or more implicit indications of whether joint or separate RS-to-RO mapping is enabled (e.g., activated) or disabled (e.g., deactivated) for different RO types. For example, the WTRU may (implicitly) determine that the same RACH configurations may be jointly used for different RO types if the WTRU is configured with a single set of RACH configurations. In an example, if the WTRU receives more than one set of RACH configurations, the WTRU may use the different RACH configurations for the different RO types. In another example, if the WTRU receives a first set of RACH configurations in addition to one or more configuration information indicating offset values, delta values, and/or scaling parameters, the WTRU may determine a second set of RACH configurations based on the first RACH configuration and/or the configured offset values, delta values, and/or scaling values. In this case, the WTRU may use separate RACH configurations and/or RS-to-RO mapping for different RO types.

The WTRU may also receive other types of indications of whether joint or separate RS-to-RO mapping is enabled or disabled for different RO types.

Based on a selected RS and/or an associated RS type, the WTRU may select one or more ROs associated with the selected RS and may transmit a PRACH preamble on the selected one or more ROs. In an example, the WTRU may use a spatial filter for PRACH preamble transmission based on the selected RS. The WTRU may be configured to use the spatial filter for CORESET #0 and/or RAR reception based on the selected RS and/or an associated RS. For example, if the selected RS is a second-type RS (e.g., virtual RS), the WTRU may use a first RS as a reference. The first RS may be of a first-type RS (e.g., transmitted RS) associated with the selected RS.

In an example, if a joint RS-to-RO mapping is enabled, a WTRU may be configured with (e.g., receive configuration information indicating) a single set of RACH configurations for different RS types. For instance, the WTRU may jointly use the configured ROs regardless of RS types, wherein the WTRU may map the RSs to ROs (e.g., based on RS indexes, RS block indexes, TCI-state codepoints, etc.). In another example, the WTRU may use the different RO types based on a mode of operation (e.g., of the WTRU). In an example, if one or more ROs overlap in time and/or frequency with one or more symbols configured with a first mode of operation, the WTRU may use the first RS types for RS-to-RO mapping in the corresponding Ros. If an RO overlaps in time with one or more symbols configured with a second mode of operation, the WTRU may use the second RS types for RS-to-RO mapping in the corresponding ROs. For example, if a first set of ROs overlaps with symbols during (e.g., included in) a power-saving time duration, the WTRU may use the first RS-type as the reference for RS-to-RO mapping. If a second set of ROs overlaps with symbols during (e.g., included in) a power-saving time duration, the WTRU may use the second RS-type as the reference for RS-to-RO mapping.

In another example, if separate RS-to-RO mapping is enabled, a WTRU may receive, be configured with, and/or receive an indication of more than one set of RACH configurations for different RS types. For example, the WTRU may receive more than one index to RACH configuration tables for indicating RACH configurations for different RS types. For example, the WTRU may receive a first set of RACH configurations for the first-type ROs associated with the first-type RSs, a second set of RACH configurations for the second-type ROs associated with the second-type RSs, and so forth.

In an example, a WTRU may be configured with one or more RS-to-RO mapping methods and/or options, wherein the WTRU may determine and/or receive an indication of a method to be used. For example, the WTRU may receive configuration information indicating one or more RS-to-RO mapping methods (e.g., from a bases station via RRC, MAC-CE, DCI, SIB, as part of RS block, etc.). In an example, the configuration information may comprise one or more indications of an RS-to-RO mapping to be used.

In an example, the WTRU may be configured to use RS-to-RO mapping, where the RS-to-RO mapping may be based on RS resource indexes. As such, for a selected RS, the WTRU may send PRACH preambles in RO type(s) associated with a selected RS type, wherein RSs may be mapped to ROs based on an increasing (e.g., ascending) order, a decreasing (e.g., descending) order, and/or a configured order of the RS resource indexes.

In an example, a WTRU may be configured to use RS-block-to-RO mapping, where an RS-block-to-RO mapping may be based on RS block indexes. In an example, the WTRU may send a PRACH preamble in ROs based on RS block index, regardless of whether the first RS, the second RS, and/or or virtual RSs are selected. In an example, for a selected RS block, the WTRU may be configured to send PRACH preambles in the RO types associated with a configured RS type, wherein the RS blocks may be mapped to the ROs based on an increasing (e.g., ascending) order, a decreasing (e.g., descending) order of the RS block indexes. In an example, the WTRU may be configured to send a PRACH preamble in ROs of a first type based on an RS block index. Furthermore, the WTRU may be configured to send a PRACH preamble in ROs of a second type based the RS block index, and/or so forth.

In an example, in RS-clock-to-RO mapping, the WTRU may be configured to perform the mapping based on a first RS configured in a selected RS block. The WTRU may consider RS-block-to-RO mapping, where the RS-block-to-RO mapping may be based on the first RS resource index. In an example, for a selected RS block, the WTRU may send PRACH preambles in RO types associated with a type of the first RS in the selected RS block, where the mapping to the ROs may be based on an increasing (e.g., ascending) order, a decreasing (e.g., descending) order, and/or a configured order of the first RS resource indexes.

In an example, the WTRU may be configured to use a first RS in an RS block as a reference RS for a UL spatial filter and/or a DL spatial filter, a QCL-relation, and/or a TCI-state for PRACH preamble transmission, RAR monitoring, etc. In an example, the WTRU may use PRACH preamble partitioning and/or Msg3 indication for indicating the selected RS within the selected RS block.

In an example, the WTRU may be configured to use TCI-state-to-RO mapping, wherein the TCI-state-to-RO mapping may be based on an Identifier (ID) of the configured and/or activated TCI-states. In an example, the WTRU may be configured with one or more RSs. The WTRU may receive one or more TCI-states (e.g., receive indications of the one or more TCI-states) that may be associated with the configured RSs. The WTRU may receive TCI-state IDs (e.g., indexes and/or other types of identifiers) corresponding to the configured TCI-states. The configured RSs may be of a first type and/or a second type. In an example, for a selected RS, the WTRU may send PRACH preambles in the ROs associated with the selected RS's TCI-state ID. For example, the RSs may be mapped to ROs in an increasing (e.g., ascending) order, a decreasing (e.g., descending) order, and/or a configured order of their associated TCI-state IDs.

In another example, the TCI-state-to-RO mapping may be based on an order of received RSs (e.g., an order in time). In another example, the TCI-state-to-RO mapping may be based on a configured order of received RSs (e.g., received in an RS block). The RSs may be associated with corresponding configured and/or activated TCI-states.

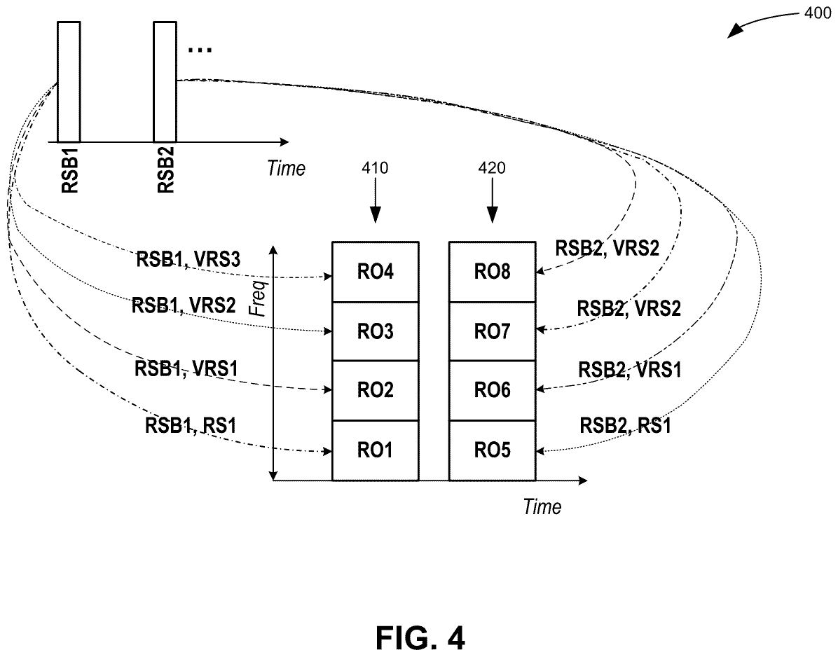

FIG. 4 depicts a diagram 400 that indicates an example of a TCI-state-to-RO mapping. In the example indicated by FIG. 4, the WTRU may receive a burst of one or more RS blocks (RSBs) (e.g., “RSB1” and “RSB2”), wherein each RSB may include a first type of RS, a second type of RS. Based on each RS block and the first RS and second RS, the UE may determine one or more virtual RSs (e.g., three virtual the second RS, which are indicated in FIG. 4 as “VRS1,” “VRS2,” and “VRS3,” respectively). In an example, the WTRU may be configured with four frequency-division multiplexed (FDMed) ROs in each RO time instance (e.g., in the diagram 400, the ROs “RO1,” “RO2,” “RO3,” and “RO4” are FDMed in a time instance 410 that corresponds to RSB1 and the ROs “RO5,” “RO6,” “RO7,” and “RO8” are FDMed in a time instance 420 that corresponds to RSB2). In this example, an RS-to-RO mapping (e.g., entries in an RS-to-RO mapping) may be ordered based on an increasing (e.g., ascending) order of RS block index, the first RS of the first type, the second RS of the first type, the first virtual RS, the second virtual RS, and so forth, in the corresponding RS block.

For example, as shown in the diagram 400, the time instance 410 (which corresponds to RSB1, which is an RSB that corresponds to an RS block index of 1) is positioned first in time ahead of the time instance 420 (which corresponds to RSB2, which is an RSB that corresponds to an RS block index of 2). Furthermore, in the time instance 410, RO1 (which is an RO corresponding to the first type of RS (“RS1”))) is positioned first relative to frequency ahead of RO2 (which is an RO corresponding to the first type of virtual RS (“VRS1”)). Similarly, in the time instance 420, RO5 (which is an RO corresponding to RS1) is positioned first relative to frequency ahead of RO6 (which is an RO corresponding to VRS1). Thus, in the example indicated by the diagram 400, non-virtual types of RSs (e.g., transmitted RS types) may be placed before virtual types of RSs in an order. In addition, virtual types of RSs may be arranged in increasing (e.g., ascending) order based on virtual-type indexes. For instance, as shown relative to frequency in the time instance 410, RO2 (which is an RO corresponding to VRS1) is positioned before RO3 (which is an RO corresponding to the second type of virtual RS (“VRS2”)) and RO3 is positioned before RO4 (which is an RO corresponding to the third type of virtual RS (“VRS3”)). Similarly, as shown relative to frequency in the time instance 420, RO6 (which is an RO corresponding to VRS1) is positioned before RO7 and RO8 (which are ROs corresponding to VRS2).

In this example, based on the selected RS, the WTRU may use the ROs associated with the selected RS and/or corresponding TCI-state and send a PRACH preamble on the selected RO. In an example, the WTRU may be configured to use the selected RS in the RS block as the reference RS for the UL spatial filter and/or DL spatial filter, QCL-relation, TCI-state for PRACH preamble transmission, RAR monitoring, etc.

In an example, a WTRU may be configured to use SRI-to-RO mapping, wherein an SRI-to-RO mapping may be based on SRIs. In an example, the WTRU may be configured to send PRACH preambles in ROs associated with SRIs that correspond to a selected RS. RSs may be mapped to the ROs based on an increasing (e.g., ascending) order, a decreasing (e.g., descending) order, and/or a configured order of the associated SRIs.

In an example, a WTRU may be in RRC-Connected state. For example, the WTRU may receive configuration information indicating one or more SRS resources. The configuration information may indicate one or more SRS resources, corresponding SRIs, TCI-states, SRS resource mapping, and so forth. In an example, the WTRU may be configured with one or more SRS resources as a reference for one or more (e.g., UL) TCI-states, spatial filters, QCL relations, etc.

In an example, a WTRU that has selected an RS (e.g., a DL RS) and determined to perform a random-access procedure based on the selected RS may determine to transmit a PRACH preamble based on a first spatial filter that corresponds to the selected RS. The WTRU may determine (e.g., identify) an SRI associated with a second spatial filter that corresponds to the first spatial filter associated with the selected RS. A first spatial filter may correspond to a second spatial filter (i) if the first spatial filter and the second spatial filter are close enough (e.g., a measurable difference between the first spatial filter and the second spatial filter does not exceed a threshold difference), (ii) if a first beam direction associated with the first spatial filter correlates with a second beam direction associated with the second spatial filter, (iii) if the first beam direction is within a range (e.g., a threshold range) of the second beam direction, and/or (iv) if a spatial filter used for the first beam direction and a spatial filter used for the second beam direction are the same spatial filter. After determining the SRI corresponding to the spatial filter of the selected RS, the WTRU may send the PRACH preamble in the ROs that may be associated with the determined SRI.

A WTRU may also use other methods of RS-to-RO mapping.

In an example, regardless of the method of RS-to-RO mapping used, a mapping to the ROs may be based on (e.g., may comprise) one-to-one associations, one-to-many associations, many-to-one associations, and so forth. For example, in a one-to-one mapping, each RS, RS block, TCI-state, and/or SRI may be mapped to a single RO. In a one-to-many mapping, each RS, RS block, TCI-state, and/or SRI may be mapped to more than one RO. In a many-to-one mapping, more than one RS, RS block, TCI-state, and/or SRI may be mapped to a single RO, and so forth.

A WTRU may be configured to receive, monitor, and/or measure one or more RSs, where the RSs may be associated (e.g., with each other). In an example, the WTRU may be configured to receive, monitor, and/or measure one or more RS blocks, wherein the one or more RS blocks may comprise a set of first RSs and a set of second RSs. Each first RS in the RS block may be associated with one or multiple second RSs. In some examples, the WTRU may report to the network one or multiple parameters related to measurement results (e.g., measurements and/or measurement values) for the first RS and/or the associated second RS. The WTRU may be configured to report one or more of the following parameters:

In an example, the WTRU may be configured to report a measured quantity parameter of the first RS. For example, the WTRU may measure the RSRP, RSSI, RSRQ, SINR, etc. of the first RS (e.g., an RSRP value of the first RS may be referred to as “RSRP1”). The WTRU may report one or more RSRP1s for different first RSs.

In an example, the WTRU may be configured to report a measured quantity parameter of the second RS. For example, the WTRU may measure the RSRP, RSSI, RSRQ, SINR, etc. of the second RS (e.g., an RSRP value of the second RS may be referred to as “RSRP2”). The WTRU may report one or more RSRP2s for different second RSs.

In an example, the WTRU may be configured to report a ratio of measured parameters. For example, the WTRU may measure and/or report a ratio between one or more measured parameters based on the first RS and the second RS. In an example, the WTRU may be configured to report a quotient of RSRP1 and RSRP2 (e.g., RSRP1 divided by RSRP2) and/or a quotient of RSRP2 and RSRP1 (e.g., RSRP2 divided by RSRP1). For example, the WTRU may calculate and/or report the ratio between the measured RSRP based on a first RS and a second RS.

In an example, the WTRU may be configured to report a difference between measured parameters. For example, the WTRU may measure and/or report the difference between one or more measured parameters based on the first RS and the second RS. In an example, the WTRU may be configured to report the difference between RSRP1 and RSRP2 (e.g., RSRP1 minus RSRP2) and/or the difference between RSRP2 and RSRP1 (e.g., RSRP2 minus RSRP1). For example, the WTRU may calculate and/or report the difference between the measured RSRP based on a first RS and a second RS.

In an example, the WTRU may be configured to report an angle of arrival (AoA) of the first RS. For example, the WTRU may determine the AoA of the first RS based on a difference of arrival time of the first RS in a multiple antenna array. The WTRU may then report the AoA of the first RS (e.g., to the network).

In an example, the WTRU may be configured to report an angle of arrival of the second RS associated with the first RS. For example, the WTRU may determine the AoA of the second RS based on a difference of arrival time of the second RS in a multiple antenna array. The WTRU may then report the AoA of the second RS (e.g., to the network).

In an example, the WTRU may be configured to report a quantized ratio and/or difference. For example, the WTRU may be configured to report one or more quantized values for a ratio and/or difference between one or more measured parameters (e.g., AoA, RSRP, RSSI, RSRQ, SINR, etc.) based on the first RS and the second RS. The quantized ratio may be associated with and/or may correspond to a difference in AOA measured based on the first RS and/or the second RS. In an example, the WTRU may be configured to report a ratio of the measured RSRP1 and RSRP2. The WTRU may send an indication of the higher measured RSRP (e.g., RSRP1 or RSRP2). For example, the WTRU may send a flag indication, wherein a first value (e.g., a value of zero) of the flag indication may indicate that RSRP1 is higher than RSRP2 and a second value (e.g., a value of one) of the flag indication may indicate that RSRP1 is lower than RSRP2. In another example, the WTRU may send an indication to indicate if the ratio and/or difference between the measured parameters based on the first RS and/or second RS is within a first range (e.g., defined by a first lower bound and a first upper bound), a second range (e.g., defined by a second lower bound and a second upper bound), and/or one or more other ranges. In an example, the WTRU may send a first value (e.g., a value of “00”) if RSRP1 is equal to RSRP2. The WTRU may send a second value (e.g., a value of “01”) if the ratio and/or difference between RSRP1 and RSRP2 is within a first range (e.g., if RSRP1 divided by RSRP2 is less than or equal to 0.25). The WTRU may send a third value (e.g., a value of “10”) if the ratio and/or difference between RSRP1 and RSRP2 is within a second range

$$( e . g . , 0.25 < \frac{RSRP 1}{RSRP 2} \leq 0.5 )$$

and/or if the ratio and/or difference between RSRP1 and RSRP2 is within a second range

$$( e . g . , 0.5 < \frac{RSRP 1}{RSRP 2} \leq 0.75 ) .$$

The WTRU may send a fourth value (e.g., a value of “11”) if the ratio and/or difference between RSRP1 and RSRP2 is within a third range

$$( e . g . , 0.75 < \frac{RSRP 1}{RSRP 2} ) .$$

In an example, the WTRU may be configured to report RS index(es) and/or virtual RS index(es) of the first RS(s) and/or the associated second RS(s). The WTRU may determine the first RS(s) (e.g., the “best” RS(s)) using the RSRP measurements (e.g., the first RS may be the RS with the highest RSRP measurement(s)). In another example, the WTRU may determine the first RS(s) using AoA (e.g., the first RS may be the RS with an AoA that equals, or is within a threshold angular distance of, a pre-configured angle value). In one example, the WTRU may be configured to report the RS indexes of the N RSs (e.g., the first RSs) with highest RSRP measurements (e.g., wherein N may be a non-negative integer, and wherein each respective RSRP measurement for each of the N RSs may be greater than the respective RSRPs of RSs not included in the N RSs) and the RS indexes of the second RSs that are associated with the N RSs. In another example, the WTRU may be configured to report the RS indexes of the N virtual RSs with highest RSRP measurements (e.g., wherein each respective RSRP measurement for each of the N virtual RSs may be greater than the respective RSRPs of virtual RSs not included in the N virtual RSs).

In an example, the WTRU may be configured to report an angle (0) determined from the measured RSRPs and/or relative phases of the first RS and the second RS and/or from a function f(θ) and/or at least one parameter (K) (e.g., as described above) The WTRU may also be configured to report other parameters.

In some examples, the WTRU may be configured to report the parameters described above using an Msg3 transmission (e.g., a scheduled uplink transmission after the PRACH preamble is transmitted). The WTRU may receive an indication in an Msg2 transmission (e.g., a downlink transmission received after the PRACH preamble is transmitted) requesting that the WTRU transmit one or more parameters in Msg3. For example, a bitfield in a DCI-scheduling PDSCH carrying a random-access response (RAR) may indicate to the WTRU which parameter from a pre-configured list of parameters the WTRU may report in the Msg3 transmission. In another example, a PDSCH carrying the RAR may indicate which parameters the WTRU may report in the Msg3 transmission.

In some examples, a WTRU may be configured to transmit a sounding reference signal (SRS) to a base station (e.g., gNB) after transmitting an Msg1 transmission (e.g., transmitting a PRACH). Such an Msg1 transmission may assist the network in a beam refinement procedure. In one example, the WTRU may be pre-configured with multiple SRS resources. Each SRS resource may be associated with a first RS and/or a second RS within an RS block. Upon selecting the first RS and/or the second RS, the WTRU may select the associated SRS resource for transmission. In another example, each value of the parameters described above may be associated with an SRS resource. For example, a first range for RSRP1 may be associated with a first SRS resource and a second range for RSRP1 may be associated with a second SRS resource. If the WTRU measures the first SRS resource and determines that the RSRP (e.g., RSRP1) is within the first range, the WTRU may select the first SRS resource for transmission. In another example, a first range for RSRP2 may be associated with a first SRS resource and a second range for RSRP2 may be associated with a second SRS resource. If the WTRU measures the second SRS resource and determines that the RSRP (e.g., RSRP2) is within the first range (e.g., for RSRP2), the WTRU may select the first SRS resource for transmission. The WTRU may be configured with an association between a PRACH resource and an SRS resource. Upon selecting a PRACH resource for transmission, the WTRU may select the associated SRS resource for transmission after an Msg1 transmission. In another example, the network may indicate, to the WTRU, the SRS resource to use for transmission after an Msg1 transmission. In another examples, the WTRU may be configured to transmit an SRS to the base station (e.g., gNB) after an Msg3 transmission. The WTRU may receive an indication in the Msg2 transmission to transmit an SRS resource and/or an indication of which resource to use for SRS transmission.

A WTRU may be configured with a CSI measurement and/or reporting procedure that involves a reduced amount of CSI-RS overhead. In an example, a WTRU may be in RRC-Connected state. The WTRU may receive an indication to perform a CSI measurement and/or reporting procedure based on reduced CSI-RS overhead via differential beam refinement. In an example, the WTRU may be configured to receive and/or measure one or more first-type RSs (e.g., a portion of CSI-RSs—e.g., 8 CSI-RSs out of 32 CSI-RSs). The WTRU may report a CSI resource index (CRI) of a selected and/or configured first RS (e.g., with a highest RSRP) in addition to a ratio and/or difference between measured parameters based on the first RS and an associated second RS. One benefit that may result from this approach may be that, after WTRU reports the ratios, the NW sends a portion of CSI-RSs for beam selection.

In another example, for MIMO and/or during connected mode, unless CSI-RSs are being transmitted, beam refinement (e.g., associated with the beam selection mentioned above) may be used as a reference for a QCL assumption. In an example, the WTRU may be configured to determine and/or report one or more second-type RSs (e.g., virtual RSs) based on the measured one or more first-type RSs. For example, the WTRU may send the report as part of a configured CSI report. For example, the WTRU may receive one or more CSI report configurations (e.g., in CSI report configuration information). The CSI report configurations may include one or more indications of one or more quality parameters to be measured in addition to one or more parameters (e.g., other than the one or more quality parameters), events, and/or indications to be reported. The WTRU may receive the CSI report configuration information that instructs (e.g., configures) the WTRU to measure and/or report via RRC, MAC-CE, DCI, SIB, as part of an RS block, etc. In an example, the WTRU may be configured to report the index(es) of one or more selected, configured, and/or determined RSs, wherein the determined RSs may be of a second type (e.g., virtual RSs). The WTRU may be configured to report one or more parameters (e.g., as described above).

1. A wireless transmit/receive unit (WTRU) comprising:
a processor configured to:
receive a plurality of reference signals associated with each other;
select a first reference signal of the plurality of reference signals based on a measured channel quality parameter associated with the first reference signal, wherein the first reference signal is associated with a second reference signal;
receive configuration information associated with random access, wherein the configuration information comprises information associated with virtual reference signals;
select, from the virtual reference signals, a virtual reference signal to be used for random access based on the first reference signal and the second reference signal; and
transmit a Physical Random-Access Channel (PRACH) preamble via a random access occasion associated with the selected virtual reference signal.

2. The WTRU of claim 1, wherein the first reference signal is associated with a first beam direction and the second reference signal is associated with a second beam direction.

3. The WTRU of claim 1, wherein the virtual reference signals are not actually transmitted by a network.

4. The WTRU of claim 1, wherein the configuration information comprises a channel quality threshold associated with the virtual reference signals.

5. The WTRU of claim 1, wherein the configuration information comprises (i) an indication of a first random access configuration associated with the first reference signal and the second references signal and (i) an indication of a second random access configuration associated with the virtual reference signals.

6. The WTRU of claim 1, wherein the processor is configured to:
select the virtual reference signal based on the measured channel quality parameter associated with the first reference signal and a measured channel quality parameter associated with the second reference signal.

7. The WTRU of claim 1, wherein the processor is configured to:
send a report, wherein the report comprises an indication of (i) the measured channel quality parameter associated with the first reference signal, (ii) a measured channel quality parameter associated with the second reference signal, or (ii) a ratio of the measured channel quality parameter associated with the first reference signal and the measured channel quality parameter associated with the second reference signal.

8. The WTRU of claim 1, wherein the first reference signal, the second reference signal, and the virtual reference signal are associated with different random access occasions.

9. The WTRU of claim 1, wherein the plurality of reference signals is associated with a plurality of reference signal blocks, and wherein the first reference signal being associated with the second reference signal comprises:
the first reference signal being associated with a first reference signal block of the plurality of reference signal blocks; and
the first reference signal block being associated with the second reference signal.

10. The WTRU of claim 9, wherein the first reference signal and the second reference signal are multiplexed in time within the first reference signal block.

11. The WTRU of claim 1, wherein a first beam direction associated with the first reference signal is associated with a wide beam, and wherein a second beam direction associated with the second reference signal is associated with a differential beam.

12. The WTRU of claim 11, wherein a first Transmission Control Indicator (TCI) state is associated with the first reference signal and the first beam direction, and wherein a second TCI state is associated with the second reference signal and the second beam direction.

13. The WTRU of claim 12, wherein the processor is configured to:
determine the channel quality parameter for the first reference signal and the channel quality parameter for the second reference signal based on the first TCI state and the second TCI state, respectively.

14. A method performed by a wireless transmit/receive unit (WTRU), the method comprising:
receiving a plurality of reference signals associated with each other;
selecting a first reference signal of the plurality of reference signals based on a measured channel quality parameter associated with the first reference signal, wherein the first reference signal is associated with a second reference signal;
receiving configuration information associated with random access, wherein the configuration information comprises information associated with virtual reference signals;
selecting, from the virtual reference signals, a virtual reference signal to be used for random access based on the first reference signal and the second reference signal; and
transmitting a Physical Random-Access Channel (PRACH) preamble via a random access occasion associated with the selected virtual reference signal.

15. The method of claim 14, wherein the first reference signal is associated with a first beam direction and the second reference signal is associated with a second beam direction.

16. The method of claim 14, wherein the virtual reference signals are not actually transmitted by a network.

17. The method of claim 14, wherein the configuration information comprises a channel quality threshold associated with the virtual reference signals.

18. The method of claim 14, wherein the configuration information comprises (i) an indication of a first random access configuration associated with the first reference signal and the second references signal and (i) an indication of a second random access configuration associated with the virtual reference signals.

19. The method of claim 14, further comprising:
selecting the virtual reference signal based on the measured channel quality parameter associated with the first reference signal and a measured channel quality parameter associated with the second reference signal.

20. The method of claim 14, further comprising:
sending a report, wherein the report comprises an indication of (i) the measured channel quality parameter associated with the first reference signal, (ii) a measured channel quality parameter associated with the second reference signal, or (ii) a ratio of the measured channel quality parameter associated with the first reference signal and the measured channel quality parameter associated with the second reference signal.
